(19) United States
(12) Patent Application Publication
(10) Pub. No.: US 2020/0179848 A1
(43) Pub. Date: Jun. 11, 2020

(54) NANOFIBERS COMPRISING NANOPARTICLES

(71) Applicant: Hollingsworth & Vose Company, East Walpole, MA (US)

(72) Inventors: Keith Higginson, Holden, MA (US); Andrew Willis, Franklin, MA (US)

(73) Assignee: Hollingsworth & Vose Company, East Walpole, MA (US)

(21) Appl. No.: 16/210,482

(22) Filed: Dec. 5, 2018

(51) Int. Cl. B01D 39/16; D04H 1/728; B01D 39/20

(52) U.S. Cl. CPC B01D 39/1623; D04H 1/728; B01D 39/2072; B01D 2239/025; B01D 2239/0631; B82Y 30/00; B01D 2239/1233; B01D 2239/0258; B01D 2239/1216; B01D 2239/1291; B01D 2239/0654

(57) ABSTRACT

Articles and methods relating to filter media are generally provided. In some embodiments, a filter media comprises a non-woven fiber web and a backer layer. The non-woven fiber web may comprise a plurality of continuous nanofibers, e.g., continuous nanofibers having an average diameter of less than or equal to 250 nm. The plurality of the nanofibers may comprise a plurality of nanoparticles at least partially embedded therein. In some embodiments, the plurality of nanoparticles makes up less than or equal to 15 wt % of the plurality of nanofibers. In some embodiments, a solidity of the non-woven fiber web is less than or equal to a solidity of the backer layer.

### FIELD

The present invention relates generally to filter media, and, more particularly, to filter media including nanofibers comprising nanoparticles.

### BACKGROUND

Filter media may be used to remove one or more contaminants from a fluid. Some filter media include nanofiber layers that increase their filtration performance. However, these nanofiber layers may have a relatively high solidity, which may undesirably decrease the permeability and/or gamma of the filter media. Accordingly, improved filter media and associated compositions and methods are needed.

### SUMMARY

Filter media, related components, and related methods are generally described.

In some embodiments, a filter media is provided. The filter media comprises a non-woven fiber web comprising a plurality of continuous nanofibers having an average diameter of less than or equal to 250 nm and a backer layer. The plurality of nanofibers comprises a plurality of nanoparticles at least partially embedded therein. The plurality of nanoparticles makes up less than or equal to 15 wt % of the plurality of nanofibers. The solidity of the non-woven fiber web is less than or equal to a solidity of the backer layer.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a schematic depiction of a nanofiber layer, according to some embodiments;

FIGS. 2A-2B are schematic depictions of filter media, according to some embodiments;

FIG. 3A is a schematic depiction of a nanoparticle located in an interior of a nanofiber, according to some embodiments;

FIGS. 3B-3C are schematic depictions of nanoparticles partially embedded in nanofibers, according to some embodiments;

FIG. 3D is a schematic depiction of one example of a nanoparticle that is not embedded in a nanofiber;

FIG. 3E is a schematic depiction of one example of a nanoparticle and a nanofiber that are separate from each other;

FIG. 4 is a plot showing solidity as a function of basis weight, according to some embodiments;

FIGS. 5-6 are scanning electron micrographs of nanofibers, according to some embodiments; and

FIGS. 7-8 are transmission electron micrographs of nanofibers, according to some embodiments.

### DETAILED DESCRIPTION

Articles and methods involving filter media are generally provided. In some embodiments, a filter media comprises a non-woven fiber web comprising a plurality of continuous nanofibers (referred to elsewhere herein as a nanofiber layer) and a backer layer. The nanofiber layer may include nanofibers comprising a plurality of nanoparticles. Without wishing to be bound by any particular theory, in some embodiments, the plurality of nanoparticles may advantageously increase the mechanical robustness of the nanofiber layer, which may cause desirable improvements in one or more properties of the nanofiber layer. For instance, increasing the mechanical robustness of the nanofiber layer may reduce the tendency of the nanofiber layer to collapse on itself, a disadvantage that becomes increasingly likely and deleterious at higher basis weights of the nanofiber layer. This collapse may undesirably cause the nanofiber layer to become less open, as evidenced by a higher solidity, causing decreases in air permeability, gamma, and initial beta ratio and/or efficiency at a variety of particle sizes and/or test conditions. Therefore, the presence of nanoparticles that reinforce the nanofiber layer and reduce or prevent this collapse may be desirable. In some embodiments, particular nanoparticle and nanofiber configurations may be especially advantageous. For instance, in some embodiments, the nanoparticles may be substantially unaggregated in the nanofibers. Without wishing to be bound by any particular theory, it is believed that the presence of aggregates may be undesirable because they may provide less mechanical reinforcement of the nanofibers than nanoparticles dispersed in the nanofibers. This may be because the effects of aggregated nanoparticles may be concentrated in a few locations within the nanofibers (i.e., the aggregates), while dispersed nanoparticles may reinforce substantially the entire nanofibers. Nanofibers in which the nanoparticles are substantially unaggregated may be achieved by a variety of strategies. For instance, the wt % of nanoparticles in the nanofibers may be selected to be large enough to provide the desired reinforcement but small enough so that aggregation is suppressed. As another example, nanoparticles may be selected to have an advantageous interaction with another component of the nanofibers (e.g., a chemical, physical, electrostatic, or other type of interaction with a polymeric component of the nanofibers) that suppresses aggregation of the nanoparticles therein. As a third example, the nanofiber layer may be formed by an electrospinning process, and the solvent employed during electrospinning may be selected such that the nanoparticles disperse therein (e.g., do not form visible aggregates therein and/or remain suspended for an appreciable period of time, such as a period of time of greater than or equal to one day) and such that the dispersion has a viscosity indicative of an advantageous dispersion of the nanoparticles therein (e.g., a viscosity appropriately low such that nanofibers of a desirable diameter can be readily formed and/or a viscosity that is not indicative of gelation). Other strategies to suppress aggregation of nanoparticles in nanofibers may also be employed.

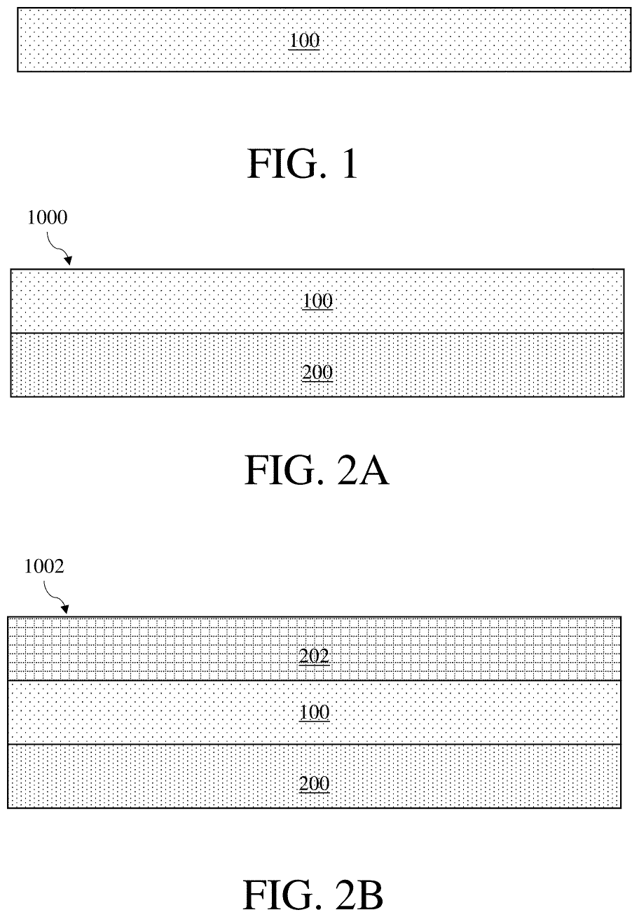

As described above, some embodiments relate to a nanofiber layer. FIG. 1 shows one example of a nanofiber layer 100. In some embodiments, the nanofiber layer may be positioned in a filter media further comprisinone or more other layers, such as a backer layer. FIG. 2A shows one example of a filter media 1000 comprising a nanofiber layer 100 and a backer layer 200. The nanofiber layer is typically, but not always, positioned directly adjacent to the backer layer. For instance, in some embodiments in which the nanofiber layer is not directly adjacent to the backer layer, an additional layer is positioned between the nanofiber layer and the backer layer. When the nanofiber layer and the backer layer are directly adjacent, they may be joined by an adhesive positioned therebetween. In some embodiments, the filter media may further comprise one or more additional layers (e.g., a second nanofiber layer, one or more prefilter layers, one or more protecting layers, etc.). FIG. 2B shows one example of a filter media 1002 comprising a nanofiber layer 100, a backer layer 200, and an additional layer 202. When present the additional layer(s) may be positioned in a variety of suitable locations. For instance, an additional layer may be positioned adjacent or directly adjacent to a backer layer, and/or an additional layer may be positioned adjacent or directly adjacent to a nanofiber layer (e.g., as shown in FIG. 2B).

As used herein, when a layer is referred to as being “on” or “adjacent” another layer, it can be directly on or adjacent the layer, or an intervening layer also may be present. A layer that is “directly on”, “directly adjacent” or “in contact with” another layer means that no intervening layer is present.

As described above, some filter media include a nanofiber layer. The nanofiber layer may serve as the efficiency layer for the filter media. In other words, it may contribute appreciably to the filtration performance of the filter media.

As described above, some filter media described herein comprise one or more nanofiber layers. It should be understood that any individual nanofiber layer may independently have some or all of the properties described below with respect to nanofiber layers. It should also be understood that a filter media may comprise two nanofiber layers that are identical and/or may comprise two or more nanofiber layers that differ in one or more ways.

When present, a nanofiber layer typically comprises a non-woven fiber web comprising a plurality of nanofibers. In some embodiments, the nanofiber layer comprises an electrospun non-woven fiber web.

When present, a nanofiber layer may comprise a plurality of nanofibers comprising a variety of suitable types of nanofibers. In some embodiments, the plurality of nanofibers may comprise one or more synthetic polymers. Non-limiting examples of suitable synthetic polymers include polyamides (e.g., Nylons, such as Nylon 6), polyesters (e.g., poly(caprolactone), poly(butylene terephthalate)), polyurethanes, polyureas, acrylics, polymers comprising a side chain comprising a carbonyl functional group (e.g., poly(vinyl acetate), cellulose, cellulose ester, poly(acrylamide)), poly(ether sulfone), polyacrylics (e.g., poly(acrylonitrile), poly(acrylic acid)), fluorinated polymers (e.g., poly(vinylidene difluoride)), polyols (e.g., poly(vinyl alcohol)), polyethers (e.g., poly(ethylene oxide)), poly(vinyl pyrrolidone), poly(allylamine), butyl rubber, polyethylene, polymers comprising a silane functional group, polymers comprising a thiol functional group, polymers comprising a methylol functional group (e.g., phenolic polymers, melamine polymers, melamine-formaldehyde polymers, cross-linkable polymers comprising pendant methylol groups), and combinations thereof. In some embodiments, the plurality of nanofibers comprises nanofibers comprising a copolymer of two or more of the polymers listed above and/or a blend of two or more of the polymers listed above (e.g., a blend of a polyamide and a polyester). In embodiments in which more than one nanofiber layer is present, each nanofiber layer may independently comprise nanofibers comprising one or more of the polymers described above.

In some embodiments, a polymer that has an advantageous interaction with the nanoparticles also present in the nanofibers, such as an interaction that promotes dispersion of the nanoparticles in the nanofibers, may be employed. The interaction promoting dispersion may be an interaction between the polymer and the nanoparticle that is more energetically favorable than interactions between two nanoparticles. Non-limiting examples of such interactions include hydrogen bonding interactions, ionic interactions, interactions between silane groups and silica (e.g., interactions between polymers comprising silane functional groups and silica nanoparticles), interactions between thiol functional groups and metals (e.g., interactions between polymers comprising thiol functional groups and metal nanoparticles, such as gold and/or copper nanoparticles), interactions between thiol functional groups and chalcogenides (e.g., interactions between polymers comprising thiol functional groups and chalcogenide nanoparticles), interactions between methylol functional groups and polymers (e.g., interactions between polymers comprising methylol functional groups and polymer nanoparticles), interactions between methylol functional groups and silane functional groups (e.g., interactions between polymers comprising methylol functional groups and nanoparticles comprising silane functional groups, interactions between polymers comprising silane functional groups and nanoparticles comprising methylol functional groups), and van der Waals interactions (e.g., interactions between non-polar polymers, such as butyl rubber and/or polyethylene, and nanoparticles comprising carbon, such as graphite nanoparticles and/or carbon nanotubes).

For instance, in some embodiments, a nanofiber comprises a polymer capable of forming hydrogen bonds with the nanoparticles therein. Non-limiting examples of polymers capable of forming hydrogen bonds include polymers comprising a functional group capable of forming a hydrogen bond, such as polymers comprising a carbonyl group (e.g., Nylon) and/or polymers comprising a hydroxyl group. Non-limiting examples of nanoparticles capable of forming hydrogen bonds include silica nanoparticles, aluminosilicate nanoparticles, and nanoparticles functionalized with functional groups capable of forming hydrogen bonds. By way of example, silica and aluminosilicate nanoparticles typically comprise Si—OH groups and/or bound water, both of which are capable of forming hydrogen bonds, on their surfaces. Some aluminosilicate nanoparticles have surfaces that have been further modified with ammonium salts, which are also capable of forming hydrogen bonds (and/or having desirable bonding interactions with Nylon). Other functional groups capable of forming hydrogen bonds, and with which nanoparticles may be functionalized, include —OH groups, —COOH groups, and —NH₂ groups. These, and/or other, functional groups may be formed on the nanoparticles by reaction with silanes and/or thiols comprising such functional groups.

As another example, in some embodiments, a nanofiber comprises a polymer capable of having an ionic interaction with the nanoparticles therein. The polymer may be a polyelectrolyte (i.e., a polymer comprising one or more ionizable monomers), or may be an uncharged polymer capable of interacting with charged surfaces of nanoparticles in the presence of a fluid precursor from which the nanofiber layer is formed. Non-limiting examples of such polymers include poly(vinyl pyrrolidone), poly(acrylic acid), and sulfonated polystyrene. The nanoparticle may be a charged nanoparticle and/or a nanoparticle capable of becoming charged, such as a nanoparticle that becomes charged in a fluid precursor from which the nanofiber layer is formed. Non-limiting examples of suitable fluid precursors in which nanoparticles may become charged include protic solvents, such as water and acids.

As a third example, in some embodiments, a nanofiber comprises a polymer comprising a methylol functional group and a nanoparticle comprising a polymer. For instance, the polymer may comprise a phenolic polymer, a melamine-formaldehyde polymer, and/or a cross-linkable polymer comprising pendant methylol groups. The nanoparticle may be a nanocellulose nanoparticle.

The plurality of nanofibers may have a variety of suitable average diameters. In some embodiments, a nanofiber layer comprises a plurality of nanofibers having an average diameter of greater than or equal to 50 nm, greater than or equal to 55 nm, greater than or equal to 60 nm, greater than or equal to 65 nm, greater than or equal to 70 nm, greater than or equal to 75 nm, greater than or equal to 80 nm, greater than or equal to 85 nm, greater than or equal to 100 nm, greater than or equal to 125 nm, greater than or equal to 150 nm, greater than or equal to 175 nm, greater than or equal to 200 nm, or greater than or equal to 225 nm. In some embodiments, a nanofiber layer comprises a plurality of nanofibers having an average diameter of less than or equal to 250 nm, less than or equal to 225 nm, less than or equal to 200 nm, less than or equal to 175 nm, less than or equal to 150 nm, less than or equal to 125 nm, less than or equal to 100 nm, less than or equal to 85 nm, less than or equal to 80 nm, less than or equal to 75 nm, less than or equal to 70 nm, less than or equal to 65 nm, less than or equal to 60 nm, or less than or equal to 55 nm. Combinations of the above-referenced ranges are also possible (e.g., greater than or equal to 50 nm and less than or equal to 250 nm, greater than or equal to 75 nm and less than or equal to 200 nm, or greater than or equal to 85 nm and less than or equal to 200 nm). Other ranges are also possible. In embodiments in which more than one nanofiber layer is present, each nanofiber layer may independently comprise a plurality of nanofibers having an average diameter in one or more of the ranges described above.

As described above, in some embodiments a plurality of nanofibers comprises a plurality of nanoparticles. For instance, a nanofiber layer may comprise (or consist essentially of) a plurality of nanofibers formed of a polymer and a plurality of nanoparticles. The plurality of nanoparticles may enhance the mechanical strength of the plurality of nanofibers and/or of a non-woven web formed by the plurality of nanofibers. The increased mechanical strength may reduce the degree to which the nanofiber layer collapses under its own weight during fabrication (e.g., electrospinning) and/or thereafter (e.g., during filtration), advantageously decreasing the solidity of the nanofiber layer.

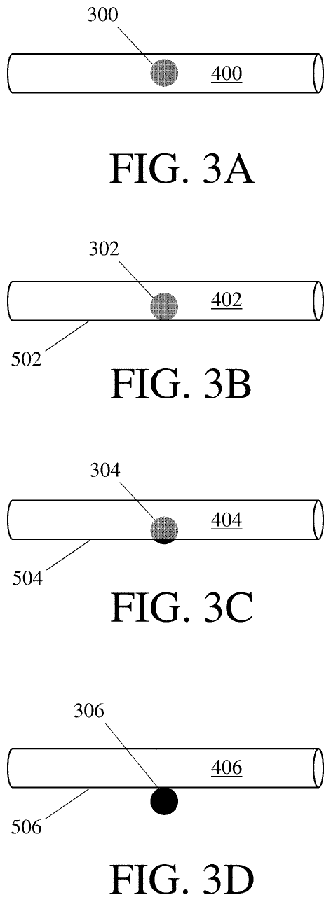

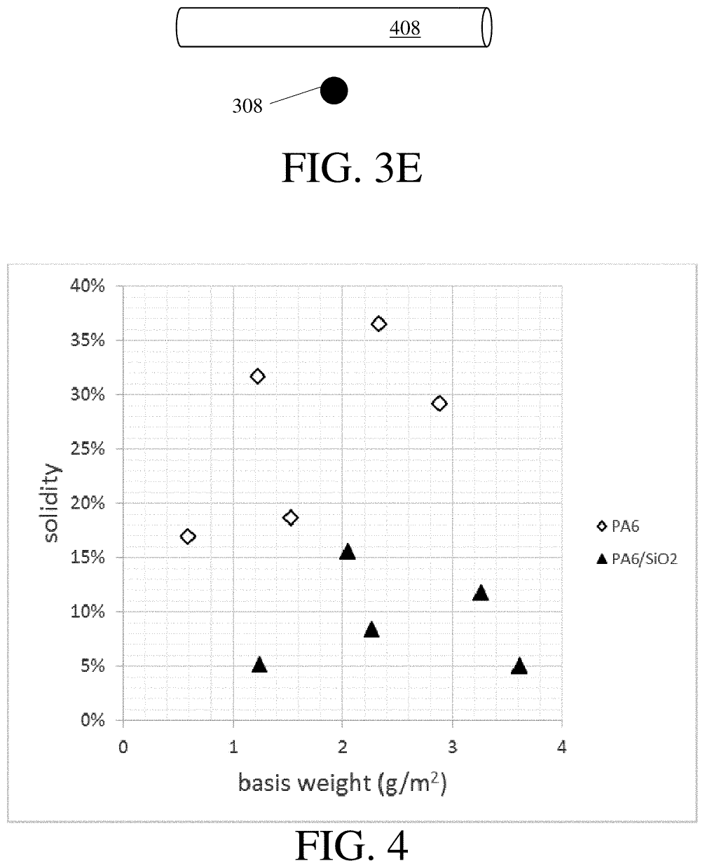

When a plurality of nanofibers comprises a plurality of nanoparticles, the nanoparticles may be positioned with respect to the nanofibers in a variety of suitable manners. In some embodiments, at least a portion (or substantially all) of the nanoparticles are at least partially embedded therein. By way of example, at least a portion (or substantially all) of the nanoparticles may be located in an interior of a nanofiber. When a nanoparticle is located in an interior of a nanofiber, it is completely or fully embedded therein. In other words, it is surrounded on all sides by other components of the nanofiber and all of its external surface is in contact with other components of the nanofiber. FIG. 3A shows one example of a nanoparticle located in an interior of a nanofiber. In FIG. 3A, a nanoparticle 300 is located in the interior of a nanofiber 400. In some embodiments, like the embodiment shown in FIG. 3A, the external surface of a nanofiber comprising a nanoparticle located in its interior does not show any indication of the presence of the nanoparticle. The external surface of the nanofiber may be substantially the same as the external surface of an otherwise equivalent nanofiber lacking the nanoparticle and/or may not include any protrusions or other features indicative of the presence of nanoparticles therein. In some embodiments, the presence of such nanoparticles are not observable by SEM. When nanoparticles are located in the interior of a nanofiber, they may be located in the interior of the same nanofiber (e.g., one nanofiber may comprise all the nanoparticles in the plurality of nanoparticles in its interior) or located in the interiors of more than one (or substantially all) of the nanofibers in the plurality of nanofibers (e.g., two or more nanofibers may comprise nanoparticles in their interiors, and all of the nanoparticles in the plurality of nanoparticles may be located interior to one of the fibers in the plurality of nanofibers).

In some embodiments, at least a portion (or substantially all) of the nanoparticles are located at a surface of a nanofiber. When a nanoparticle is located at a surface of a nanofiber, it comprises a portion that makes up a part of the surface of the nanofiber. In other words, at least a portion of the surface of the nanoparticle is not in contact with the other components of the nanofiber and is exposed to an environment external to the nanofiber. FIGS. 3B-3C show different examples of nanoparticles located at the surfaces of nanofibers. In some embodiments, like the embodiment shown in FIG. 3B, the portion of the nanoparticle at the surface of the nanofiber does not protrude beyond the portions of the nanofiber in which a non-nanoparticle component is at the surface (e.g., portions of the nanofiber surface in which a polymeric component is at the surface). In FIG. 3B, a nanofiber 402 comprises a nanoparticle 302 that is present at but does not protrude beyond the surface 502 thereof. In such embodiments, the external surface of the nanofiber may be substantially the same as the external surface of an otherwise equivalent nanofiber lacking the nanoparticle and/or may not include any protrusions or other features indicative of the presence of nanoparticles therein. In some embodiments, the presence of such nanoparticles are not observable by SEM. The presence of such nanoparticles may be observable by other techniques in some embodiments, such as by contact angle (e.g., if the nanoparticle has a different surface energy than another component making up the surface of the nanofiber, such as a polymeric component). In some embodiments, a nanofiber comprises a nanoparticle that is located at a surface thereof and protrudes beyond the portions of the nanofiber in which a non-nanoparticle component is at the surface. FIG. 3C shows an example of this type of nanoparticle. In FIG. 3C, a nanoparticle 304 protrudes beyond a surface 504 of a nanofiber 404.

In some embodiments, a plurality of nanofibers comprises a plurality of nanoparticles, and at least a portion of the nanoparticles are at least partially embedded in a nanofiber. When a nanoparticle is partially embedded in a nanofiber, it is positioned with respect to the nanofiber such that it is partially surrounded by other components of the nanofiber. In other words, the nanoparticle that is partially embedded in a nanofiber is present at the surface of the nanofiber and comprises a portion that penetrates into the interior of the nanoparticle. By way of example, in FIG. 3B, the nanoparticle 302 is partially embedded in the nanofiber 402 because its upper portion penetrates into the interior the nanofiber 402 and its lower portion is present at the surface 502 of the nanoparticle 402. Similarly, in FIG. 3C, the nanoparticle 304 is partially embedded in the nanofiber 404 because its upper portion penetrates into the interior the nanofiber 404 and its lower portion is present at the surface 504 of the nanoparticle 404 and protrudes beyond the surface 504 of the nanofiber 404. By contrast, the nanoparticle 306 in FIG. 3D is not embedded (partially or fully) in the nanofiber 406. While present at the surface, and perhaps maintained at the surface of the nanofiber by a resin coating the nanofiber and/or by other means, this nanoparticle does not penetrate into the interior of the nanofiber 406 (i.e., this nanoparticle does not penetrate into the interior of the material forming the nanofiber itself).

FIG. 3E shows one example of a nanoparticle 308 that is separate from a nanofiber 408. Here, the nanofiber and the nanoparticle are not in contact at all and the nanoparticle makes up no portion of the nanofiber. Such would be considered to be part of the filter media without being part of the nanofibers themselves. In other words, the plurality of nanofibers would not comprise such particles.

In some embodiments, a plurality of nanofibers comprises a plurality of nanoparticles, and the plurality of nanoparticles is distributed within the plurality of nanofibers in a particularly advantageous manner. For instance, the plurality of nanoparticles may be distributed within the plurality of nanofibers such that there is little or no aggregation of the nanoparticles in the nanofibers. In other embodiments, the nanoparticles may be aggregated to form clusters.

When present, a nanofiber layer may comprise a plurality of nanofibers comprising a variety of suitable types of nanoparticles. In some embodiments, the plurality of nanoparticles comprises inorganic nanoparticles. When present, the inorganic nanoparticles may comprise ceramic nanoparticles and/or metal nanoparticles. Non-limiting examples of suitable types of inorganic nanoparticles include silica nanoparticles (e.g., fumed silica nanoparticles), aluminosilicate nanoparticles, gold nanoparticles, copper nanoparticles, metal oxide nanoparticles, carbon nanoparticles, graphite nanoparticles, carbon nanotubes, chalcogenide nanoparticles (e.g., metal chalcogenide nanoparticles), clay nanoparticles, and/or quantum dots. In some embodiments, the plurality of nanoparticles comprises organic nanoparticles, such as polymer nanoparticles (e.g., nanocellulose nanoparticles). In some embodiments, the plurality of nanoparticles may comprise nanoparticles with one or more advantageous properties, such as magnetic nanoparticles, fluorescent nanoparticles, plasmonic nanoparticles, conductive nanoparticles, catalytic nanoparticles, biocidal nanoparticles, and the like. The nanoparticles are typically, but not always, uncharged. In some embodiments, the nanoparticles may be functionalized to aid compatibilization with one or more other components of the nanofiber (e.g., a polymeric component) as described above. This may desirably suppress aggregation of the nanoparticles therein. In embodiments in which more than one nanofiber layer is present, each nanofiber layer may independently comprise a plurality of nanofibers comprising one or more of the types of nanoparticles described above.

When present, the nanoparticles may have a variety of suitable average diameters. The average diameter of the nanoparticles may be greater than or equal to 2 nm, greater than or equal to 2.5 nm, greater than or equal to 3 nm, greater than or equal to 4 nm, greater than or equal to 5 nm, greater than or equal to 7.5 nm, greater than or equal to 10 nm, greater than or equal to 12.5 nm, greater than or equal to 15 nm, greater than or equal to 20 nm, greater than or equal to 25 nm, greater than or equal to 30 nm, greater than or equal to 40 nm, greater than or equal to 50 nm, or greater than or equal to 75 nm. The average diameter of the nanoparticles may be less than or equal to 100 nm, less than or equal to 75 nm, less than or equal to 50 nm, less than or equal to 40 nm, less than or equal to 30 nm, less than or equal to 25 nm, less than or equal to 20 nm, less than or equal to 15 nm, less than or equal to 12.5 nm, less than or equal to 10 nm, less than or equal to 7.5 nm, less than or equal to 5 nm, less than or equal to 4 nm, less than or equal to 3 nm, or less than or equal to 2.5 nm. Combinations of the above-referenced ranges are also possible (e.g., greater than or equal to 2 nm and less than or equal to 100 nm, greater than or equal to 5 nm and less than or equal to 50 nm, or greater than or equal to 10 nm and less than or equal to 40 nm). Other ranges are also possible. The average diameter of the nanoparticles may be determined by TEM. As used herein, the diameter of a nanoparticle is the diameter of a circle having an equivalent area to the area of the nanoparticle when measured by TEM. The average diameter of the nanoparticles is the average of the diameters of the nanoparticles in the plurality of nanoparticles. In embodiments in which more than one nanofiber layer is present, each nanofiber layer may independently comprise a plurality of nanoparticles having a diameter in one or more of the ranges described above.

When a plurality of nanofibers comprises a plurality of nanoparticles, the ratio of the average diameter of the nanofibers to the average diameter of the nanoparticles may be a variety of suitable values. In some embodiments, the ratio of the average diameter of the nanofibers to the average diameter of the nanoparticles is greater than or equal to 1, greater than or equal to 1.25, greater than or equal to 1.5, greater than or equal to 2, greater than or equal to 2.5, greater than or equal to 3, greater than or equal to 4, greater than or equal to 5, greater than or equal to 7.5, greater than or equal to 10, greater than or equal to 12.5, greater than or equal to 15, greater than or equal to 20, greater than or equal to 25, greater than or equal to 30, greater than or equal to 40, greater than or equal to 50, greater than or equal to 75, or greater than or equal to 100. In some embodiments, the ratio of the average diameter of the nanofibers to the average diameter of the nanoparticles is less than or equal to 125, less than or equal to 100, less than or equal to 75, less than or equal to 50, less than or equal to 40, less than or equal to 30, less than or equal to 25, less than or equal to 20, less than or equal to 15, less than or equal to 12.5, less than or equal to 10, less than or equal to 7.5, less than or equal to 5, less than or equal to 4, less than or equal to 3, less than or equal to 2, less than or equal to 1.5, or less than or equal to 1.25. Combinations of the above-referenced ranges are also possible (e.g., greater than or equal to 1 and less than or equal to 125, greater than or equal to 1.5 and less than or equal to 15, or greater than or equal to 2 and less than or equal to 10). Other ranges are also possible. The ratio of the average diameter of the nanofibers to the average diameter of the nanoparticles may be determined by finding the average diameter of the nanofibers and the average diameter of the nanoparticles, and then dividing the average diameter of the nanofibers by the average diameter of the nanoparticles. In embodiments in which more than one nanofiber layer is present, each nanofiber layer may independently have a ratio of the average diameter of the nanofibers to the average diameter of the nanoparticles in one or more of the ranges described above.

When a plurality of nanofibers comprises a plurality of nanoparticles, the plurality of nanoparticles may make up any suitable wt % of the plurality of nanofibers. In some embodiments, the plurality of nanoparticles makes up greater than or equal to 0.5 wt %, greater than or equal to 0.75 wt %, greater than or equal to 1 wt %, greater than or equal to 1.25 wt %, greater than or equal to 1.5 wt %, greater than or equal to 2 wt %, greater than or equal to 2.5 wt %, greater than or equal to 3 wt %, greater than or equal to 4 wt %, greater than or equal to 5 wt %, greater than or equal to 7.5 wt %, greater than or equal to 10 wt %, or greater than or equal to 12.5 wt % of the plurality of nanofibers. In some embodiments, the plurality of nanoparticles makes up less than or equal to 15 wt %, less than or equal to 12.5 wt %, less than or equal to 10 wt %, less than or equal to 7.5 wt %, less than or equal to 5 wt %, less than or equal to 4 wt %, less than or equal to 3 wt %, less than or equal to 2.5 wt %, less than or equal to 2 wt %, less than or equal to 1.5 wt %, less than or equal to 1.25 wt %, less than or equal to 1 wt %, or less than or equal to 0.75 wt % of the plurality of nanofibers. Combinations of the above-referenced ranges are also possible (e.g., greater than or equal to 0.5 wt % and less than or equal to 15 wt % of the plurality of nanofibers, greater than or equal to 1 wt % and less than or equal to 10 wt % plurality of nanofibers, or greater than or equal to 1 wt % and less than or equal to 5 wt % plurality of nanofibers). Other ranges are also possible. In embodiments in which more than one nanofiber layer is present, each nanofiber layer may independently comprise a plurality of nanoparticles making up a wt % of the plurality of nanofibers in one or more of the ranges described above. Some nanofiber layers may be formed from a fluid precursor. For instance, electrospun nanofiber layer may be formed by electrospinning a fluid precursor onto a backer to form an electrospun nanofiber layer disposed on the backer. The fluid precursor may be a solution (e.g., a fluid in which a solvent dissolves one or more solutes), a dispersion or suspension (e.g., a fluid in which one or more particles are stably dispersed, and which possibly comprises a solvent dissolving one or more solutes), or another type of suitable fluid. In some embodiments, the fluid precursor has a viscosity of greater than or equal to 100 cPs, greater than or equal to 125 cPs, greater than or equal to 150 cPs, greater than or equal to 200 cPs, greater than or equal to 250 cPs, greater than or equal to 300 cPs, greater than or equal to 400 cPs, greater than or equal to 500 cPs, greater than or equal to 750 cPs, greater than or equal to 1000 cPs, or greater than or equal to 1250 cPs. In some embodiments, the fluid precursor has a viscosity of less than or equal to 1500 cPs, less than or equal to 1250 cPs, less than or equal to 1000 cPs, less than or equal to 750 cPs, less than or equal to 500 cPs, less than or equal to 400 cPs, less than or equal to 300 cPs, less than or equal to 250 cPs, less than or equal to 200 cPs, less than or equal to 150 cPs, or less than or equal to 125 cPs. Combinations of the above-referenced ranges are also possible (e.g., greater than or equal to 100 cPs and less than or equal to 1500 cPs, or greater than or equal to 100 cPs and less than or equal to 1500 cPs). Other ranges are also possible. The viscosity of the fluid precursor may be determined by use of a rotational viscometer at a shear rate of 1.7 s⁻¹ and a temperature of 20° C. The viscosity may be determined from the rotational viscometer once the value displayed thereon has stabilized. One example of a suitable rotational viscometer is a Brookfield LVT viscometer having a No. 62 spindle. In embodiments in which more than one nanofiber layer is present, each nanofiber layer may independently be formed from a fluid precursor having a viscosity in one or more of the ranges described above.

In some embodiments, a nanofiber layer is formed from a fluid precursor that comprises nanoparticles, and the nanoparticles do not have a substantial effect on the viscosity of the fluid precursor. For instance, the viscosity of the fluid precursor may be substantially the same as an otherwise equivalent fluid precursor lacking the nanoparticles (i.e., a fluid with the same components and having the same wt % solids). The viscosity of the fluid precursor comprising the nanoparticles may be within 25%, within 20%, within 15%, within 12.5%, within 10%, within 7.5%, within 5%, within 2%, or within 1% of an otherwise equivalent fluid lacking the nanoparticles. The viscosities of the fluid precursors may be determined as described above.

When present, a nanofiber layer may have a variety of suitable solidities. In some embodiments, the solidity of a nanofiber layer is greater than or equal to 1%, greater than or equal to 2%, greater than or equal to 3%, greater than or equal to 5%, greater than or equal to 7%, greater than or equal to 10%, greater than or equal to 12%, greater than or equal to 15%, greater than or equal to 20%, or greater than or equal to 25%. In some embodiments, the solidity of a nanofiber layer is less than or equal to 30%, less than or equal to 25%, less than or equal to 20%, less than or equal to 15%, less than or equal to 12%, less than or equal to 10%, less than or equal to 7%, less than or equal to 5%, less than or equal to 3%, or less than or equal to 2%. Combinations of the above-referenced ranges are also possible (e.g., greater than or equal to 1% and less than or equal to 30%, greater than or equal to 2% and less than or equal to 20%, or greater than or equal to 3% and less than or equal to 10%). Other ranges are also possible.

The solidity of a nanofiber layer is equivalent to the percentage of the nanofiber layer occupied by solid material. One non-limiting way of determining solidity of the nanofiber layer is described in this paragraph, but other methods are also possible. The method described in this paragraph includes determining the basis weight and thickness of the nanofiber layer and then applying the following formula: solidity=[basis weight/(fiber density*thickness)]*100%. The fiber density is equivalent to the average density of the material or material(s) forming the fiber, which is typically specified by the fiber manufacturer. The average density of the materials forming the fibers may be determined by: (1) determining the total volume of all of the fibers in the nanofiber layer; and (2) dividing the total mass of all of the fibers in the nanofiber layer by the total volume of all of the fibers in the nanofiber layer. If the mass and density of each type of fiber in the nanofiber layer are known, the volume of all the fibers in the nanofiber layer may be determined by: (1) for each type of fiber, dividing the total mass of the type of fiber in the nanofiber layer by the density of the type of fiber; and (2) summing the volumes of each fiber type. If the mass and density of each type of fiber in the nanofiber layer are not known, the volume of all the fibers in the nanofiber layer may be determined in accordance with Archimedes' principle. In embodiments in which more than one nanofiber layer is present, each nanofiber layer may independently have a solidity in one or more of the ranges described above.

When both a nanofiber layer and a backer layer are present, the ratio of the solidity of the backer layer to the nanofiber layer may be a variety of suitable values. The solidity of the nanofiber layer may be less than or equal to the solidity of the backer layer. In some embodiments, the ratio of the solidity of the backer layer to the solidity of the nanofiber layer is greater than or equal to 1, greater than or equal to 1.25, greater than or equal to 1.5, greater than or equal to 2, greater than or equal to 2.5, greater than or equal to 3, greater than or equal to 3.5, greater than or equal to 4, greater than or equal to 5, greater than or equal to 6, greater than or equal to 7, or greater than or equal to 8. In some embodiments, the ratio of the solidity of the backer layer to the solidity of the nanofiber layer is less than or equal to 10, less than or equal to 8, less than or equal to 7, less than or equal to 6, less than or equal to 5, less than or equal to 4, less than or equal to 3.5, less than or equal to 3, less than or equal to 2.5, less than or equal to 2, less than or equal to 1.5, or less than or equal to 1.25. Combinations of the above-referenced ranges are also possible (e.g., greater than or equal to 1 and less than or equal to 10, greater than or equal to 1 and less than or equal to 8, or greater than or equal to 1 and less than or equal to 7). Other ranges are also possible. The ratio of the solidity of the backer layer to the solidity of the nanofiber layer may be determined by finding the solidity of the nanofiber layer and the solidity of the backer layer (e.g., by the non-limiting methods described elsewhere herein) and then dividing the solidity of the backer layer by the solidity of the nanofiber layer.

When present, a nanofiber layer may have a variety of suitable basis weights. In some embodiments, a nanofiber layer has a basis weight of greater than or equal to 0.05 g/m², greater than or equal to 0.075 g/m², greater than or equal to 0.1 g/m², greater than or equal to 0.2 g/m², greater than or equal to 0.5 g/m², greater than or equal to 0.75 g/m², greater than or equal to 1 g/m², greater than or equal to 1.5 g/m², greater than or equal to 2 g/m², greater than or equal to 2.5 g/m², greater than or equal to 3 g/m², greater than or equal to 4 g/m², greater than or equal to 5 g/m², greater than or equal to 6 g/m², or greater than or equal to 8 g/m². In some embodiments, a nanofiber layer has a basis weight of less than or equal to 10 g/m², less than or equal to 8 g/m², less than or equal to 6 g/m², less than or equal to 5 g/m², less than or equal to 4 g/m², less than or equal to 3 g/m², less than or equal to 2.5 g/m², less than or equal to 2 g/m², less than or equal to 1.5 g/m², less than or equal to 1 g/m², less than or equal to 0.75 g/m², less than or equal to 0.5 g/m², less than or equal to 0.2 g/m², less than or equal to 0.1 g/m², or less than or equal to 0.075 g/m². Combinations of the above-referenced ranges are also possible (e.g., greater than or equal to 0.05 g/m² and less than or equal to 10 g/m², greater than or equal to 0.1 g/m² and less than or equal to 5 g/m², or greater than or equal to 0.5 g/m² and less than or equal to 5 g/m²). Other ranges are also possible.

When present, a nanofiber layer may have a variety of suitable specific surface areas. In some embodiments, a nanofiber layer has a specific surface area of greater than or equal to 1 m²/g, greater than or equal to 1.25 m²/g, greater than or equal to 1.5 m²/g, greater than or equal to 2 m²/g, greater than or equal to 2.5 m²/g, greater than or equal to 3 m²/g, greater than or equal to 4 m²/g, greater than or equal to 5 m²/g, greater than or equal to 7.5 m²/g, greater than or equal to 10 m²/g, greater than or equal to 12.5 m²/g, greater than or equal to 15 m²/g, greater than or equal to 20 m²/g, greater than or equal to 25 m²/g, greater than or equal to 30 m²/g, greater than or equal to 40 m²/g, or greater than or equal to 50 m²/g, or greater than or equal to 60 m²/g. In some embodiments, a nanofiber layer has a specific surface area of less than or equal to 66 m²/g, less than or equal to 60 m²/g, less than or equal to 50 m²/g, less than or equal to 40 m²/g, less than or equal to 30 m²/g, less than or equal to 25 m²/g, less than or equal to 20 m²/g, less than or equal to 15 m²/g, less than or equal to 12.5 m²/g, less than or equal to 10 m²/g, less than or equal to 7.5 m²/g, less than or equal to 5 m²/g, less than or equal to 4 m²/g, less than or equal to 3 m²/g, less than or equal to 2.5 m²/g, less than or equal to 2 m²/g, less than or equal to 1.5 m²/g, or less than or equal to 1.25 m²/g. Combinations of the above-referenced ranges are also possible (e.g., greater than or equal to 1 m²/g and less than or equal to 66 m²/g). Other ranges are also possible. The specific surface area of a nanofiber layer may be determined in accordance with section 10 of Battery Council International Standard BCIS-03A (2009), “Recommended Battery Materials Specifications Valve Regulated Recombinant Batteries”, section 10 being “Standard Test Method for Surface Area of Recombinant Battery Separator Mat”. Following this technique, the specific surface area is measured via adsorption analysis using a BET surface analyzer (e.g., Micromeritics Gemini III 2375 Surface Area Analyzer) with nitrogen gas; the sample amount is between 0.5 and 0.6 grams in a 3/4″ tube; and, the sample is allowed to degas at 100° C. for a minimum of 3 hours. In embodiments in which more than one nanofiber layer is present, each nanofiber layer may independently have a specific surface area in one or more of the ranges described above.

When present, a nanofiber layer may have a variety of suitable thicknesses. In some embodiments, a nanofiber layer has a thickness of greater than or equal to 0.5 microns, greater than or equal to 0.75 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 20 microns, greater than or equal to 25 microns, greater than or equal to 30 microns, greater than or equal to 40 microns, greater than or equal to 50 microns, greater than or equal to 75 microns, greater than or equal to 100 microns, greater than or equal to 125 microns, or greater than or equal to 150 microns. In some embodiments, a nanofiber layer has a thickness of less than or equal to 200 microns, less than or equal to 150 microns, less than or equal to 125 microns, less than or equal to 100 microns, less than or equal to 75 microns, less than or equal to 50 microns, less than or equal to 40 microns, less than or equal to 30 microns, less than or equal to 25 microns, less than or equal to 20 microns, less than or equal to 15 microns, less than or equal to 12.5 microns, less than or equal to 10 microns, less than or equal to 7.5 microns, less than or equal to 5 microns, less than or equal to 4 microns, less than or equal to 3 microns, less than or equal to 2.5 microns, less than or equal to 2 microns, less than or equal to 1.5 microns, less than or equal to 1.25 microns, less than or equal to 1 micron, or less than or equal to 0.75 microns. Combinations of the above-referenced ranges are also possible (e.g., greater than or equal to 0.5 microns and less than or equal to 200 microns, greater than or equal to 1 micron and less than or equal to 200 microns, or greater than or equal to 5 microns and less than or equal to 200 microns). Other ranges are also possible. The thickness of a nanofiber layer may be determined by cross-sectional SEM. In embodiments in which more than one nanofiber layer is present, each nanofiber layer may independently have a thickness in one or more of the ranges described above.

When present, a nanofiber layer may have a variety of suitable mean flow pore sizes. In some embodiments, a nanofiber layer has a mean flow pore size of greater than or equal to 0.1 micron, greater than or equal to 0.125 microns, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 7.5 microns, greater than or equal to 10 microns, greater than or equal to 12.5 microns, or greater than or equal to 15 microns. In some embodiments, a nanofiber layer has a mean flow pore size of less than or equal to 20 microns, less than or equal to 15 microns, less than or equal to 12.5 microns, less than or equal to 10 microns, less than or equal to 7.5 microns, less than or equal to 5 microns, less than or equal to 4 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.75 microns, less than or equal to 0.5 microns, less than or equal to 0.4 microns, less than or equal to 0.3 microns, less than or equal to 0.25 microns, less than or equal to 0.2 microns, less than or equal to 0.15 microns, or less than or equal to 0.125 microns. Combinations of the above-referenced ranges are also possible (e.g., greater than or equal to 0.1 micron and less than or equal to 20 microns, greater than or equal to 0.1 micron and less than or equal to 10 microns, or greater than or equal to 0.2 microns and less than or equal to 5 microns). Other ranges are also possible. The mean flow pore size of a nanofiber layer may be determined in accordance with ASTM F316 (2003). In embodiments in which more than one nanofiber layer is present, each nanofiber layer may independently have a mean flow pore size in one or more of the ranges described above.

When present, a nanofiber layer may have a variety of suitable maximum pore sizes. In some embodiments, a nanofiber layer has a maximum pore size of greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 20 microns, or greater than or equal to 25 microns. In some embodiments, a nanofiber layer has a maximum pore size of less than or equal to 30 microns, less than or equal to 25 microns, less than or equal to 20 microns, less than or equal to 15 microns, less than or equal to 12.5 microns, less than or equal to 10 microns, less than or equal to 7.5 microns, less than or equal to 5 microns, less than or equal to 4 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.75 microns, less than or equal to 0.5 microns, less than or equal to 0.4 microns, less than or equal to 0.3 microns, or less than or equal to 0.25 microns. Combinations of the above-referenced ranges are also possible (e.g., greater than or equal to 0.2 microns and less than or equal to 30 microns, greater than or equal to 0.2 microns and less than or equal to 20 microns, or greater than or equal to 0.3 microns and less than or equal to 15 microns). Other ranges are also possible. The maximum pore size of a nanofiber layer may be determined in accordance with ASTM F316 (2003). In embodiments in which more than one nanofiber layer is present, each nanofiber layer may independently have a maximum flow pore size in one or more of the ranges described above.

When present, a nanofiber layer may have a variety of suitable ratios of maximum pore size to mean flow pore size. In some embodiments, a nanofiber layer has a ratio of maximum pore size to mean flow pore size of greater than or equal to 1.3, greater than or equal to 1.5, greater than or equal to 1.75, greater than or equal to 2, greater than or equal to 2.5, greater than or equal to 3, greater than or equal to 4, greater than or equal to 5, greater than or equal to 7.5, greater than or equal to 10, greater than or equal to 12.5, or greater than or equal to 15. In some embodiments, a nanofiber layer has a ratio of maximum pore size to mean flow pore size of less than or equal to 20, less than or equal to 15, less than or equal to 12.5, less than or equal to 10, less than or equal to 7.5, less than or equal to 5, less than or equal to 4, less than or equal to 3, less than or equal to 2.5, less than or equal to 2, less than or equal to 1.75, or less than or equal to 1.5. Combinations of the above-referenced ranges are also possible (e.g., greater than or equal to 1.3 and less than or equal to 20, greater than or equal to 1.3 and less than or equal to 10, or greater than or equal to 1.3 and less than or equal to 5). Other ranges are also possible. The ratio of maximum pore size to mean flow pore size of a nanofiber layer may be determined by finding the maximum pore size and mean flow pore size in accordance with ASTM F316 (2003) and then dividing the maximum pore size by the mean flow pore size. In embodiments in which more than one nanofiber layer is present, each nanofiber layer may independently have a ratio of maximum flow pore size to mean flow pore size in one or more of the ranges described above. When present, a nanofiber layer may have a variety of suitable air permeabilities. In some embodiments, a nanofiber layer has an air permeability of greater than or equal to 0.5 CFM, greater than or equal to 0.75 CFM, greater than or equal to 1 CFM, greater than or equal to 1.25 CFM, greater than or equal to 1.5 CFM, greater than or equal to 2 CFM, greater than or equal to 2.5 CFM, greater than or equal to 3 CFM, greater than or equal to 4 CFM, greater than or equal to 5 CFM, greater than or equal to 7.5 CFM, greater than or equal to 10 CFM, greater than or equal to 12.5 CFM, greater than or equal to 15 CFM, greater than or equal to 20 CFM, greater than or equal to 25 CFM, greater than or equal to 30 CFM, greater than or equal to 40 CFM, greater than or equal to 50 CFM, or greater than or equal to 75 CFM. In some embodiments, a nanofiber layer has an air permeability of less than or equal to 100 CFM, less than or equal to 75 CFM, less than or equal to 50 CFM, less than or equal to 40 CFM, less than or equal to 30 CFM, less than or equal to 25 CFM, less than or equal to 20 CFM, less than or equal to 15 CFM, less than or equal to 12.5 CFM, less than or equal to 10 CFM, less than or equal to 7.5 CFM, less than or equal to 5 CFM, less than or equal to 4 CFM, less than or equal to 3 CFM, less than or equal to 2.5 CFM, less than or equal to 2 CFM, less than or equal to 1.5 CFM, less than or equal to 1.25 CFM, less than or equal to 1 CFM, or less than or equal to 0.75 CFM. Combinations of the above-referenced ranges are also possible (e.g., greater than or equal to 0.5 CFM and less than or equal to 100 CFM, greater than or equal to 1 CFM and less than or equal to 100 CFM, or greater than or equal to 1 CFM and less than or equal to 50 CFM). Other ranges are also possible. The air permeability of a nanofiber layer may be determined in accordance with ASTM Test Standard D737-04 (2016) at a pressure of 125 Pa. In embodiments in which more than one nanofiber layer is present, each nanofiber layer may independently have an air permeability in one or more of the ranges described above.

When present, a nanofiber layer may have a variety of suitable water permeabilities. In some embodiments, a nanofiber layer has a water permeability of greater than or equal to 1.5 mL/(min*cm²*psi), greater than or equal to 1.75 mL/(min*cm²*psi), greater than or equal to 2 mL/(min*cm²*psi), greater than or equal to 2.25 mL/(min*cm²*psi), greater than or equal to 2.5 mL/(min*cm²*psi), greater than or equal to 2.75 mL/(min*cm²*psi), greater than or equal to 3 mL/(min*cm²*psi), greater than or equal to 3.25 mL/(min*cm²*psi), greater than or equal to 3.5 mL/(min*cm²*psi), greater than or equal to 3.75 mL/(min*cm²*psi), greater than or equal to 4 mL/(min*cm²*psi), greater than or equal to 5 mL/(min*cm²*psi), greater than or equal to 6 mL/(min*cm²*psi), greater than or equal to 7 mL/(min*cm²*psi), greater than or equal to 8 mL/(min*cm²*psi), greater than or equal to 9 mL/(min*cm²*psi), greater than or equal to 10 mL/(min*cm²*psi), greater than or equal to 12.5 mL/(min *cm²*psi), greater than or equal to 15 mL/(min*cm²*psi), or greater than or equal to 20 mL/(min*cm²*psi). In some embodiments, a nanofiber layer has a water permeability of less than or equal to 25 mL/(min*cm²*psi), less than or equal to 20 mL/(min*cm²*psi), less than or equal to 15 mL/(min*cm²*psi), less than or equal to 12.5 mL/(min*cm²*psi), less than or equal to 10 mL/(min*cm²*psi), less than or equal to 9 mL/(min*cm²*psi), less than or equal to 8 mL/(min*cm²*psi), less than or equal to 7 mL/(min*cm²*psi), less than or equal to 6 mL/(min*cm²*psi), less than or equal to 5 mL/(min*cm²*psi), less than or equal to 4 mL/(min*cm²*psi), less than or equal to 3.75 mL/(min*cm²*psi), less than or equal to 3.5 mL/(min*cm²*psi), less than or equal to 3.25 mL/(min*cm²*psi), less than or equal to 3 mL/(min*cm²*psi), less than or equal to 2.75 mL/(min*cm²*psi), less than or equal to 2.5 mL/(min*cm²*psi), less than or equal to 2.25 mL/(min*cm²*psi), less than or equal to 2 mL/(min*cm²*psi), or less than or equal to 1.75 mL/(min*cm²*psi). Combinations of the above-referenced ranges are also possible (e.g., greater than or equal to 1.5 mL/(min*cm²*psi) and less than or equal to 25 mL/(min*cm²*psi), greater than or equal to 1.5 mL/(min*cm²* psi) and less than or equal to 10 mL/(min*cm²*psi), greater than or equal to 2 mL/(min*cm²*psi) and less than or equal to 8 mL/(min*cm²*psi), or greater than or equal to 4 mL/(min*cm²*psi) and less than or equal to 6 mL/(min*cm²*psi)). Other ranges are also possible. The water permeability of a nanofiber layer may be determined by exposing a sample of the nanofiber layer with an area of 4.8 cm² to deionized water at a constant pressure of 20 psi and collecting the water that flows through the sample of the nanofiber layer. The time required for 1000 mL of water to flow through the sample of the nanofiber layer is determined, and then the water permeability is determined using the following formula:

$$Water permeability = \frac{1000 mL}{measured time in minutes * 4.8 {cm}^{2} * 20 psi} .$$

Prior to exposing the nanofiber layer to the deionized water, the sample of the nanofiber layer is first immersed in isopropanol and then in deionized water. In embodiments in which more than one nanofiber layer is present, each nanofiber layer may independently have a water permeability in one or more of the ranges described above.

When present, a nanofiber layer may have a variety of suitable water contact angles. In some embodiments, a nanofiber layer has a water contact angle of greater than or equal to 45°, greater than or equal to 50°, greater than or equal to 60°, greater than or equal to 70°, greater than or equal to 80°, greater than or equal to 90°, greater than or equal to 100°, greater than or equal to 110°, greater than or equal to 120°, greater than or equal to 135°, greater than or greater than or equal to 150°, or greater than or equal to 175°. In some embodiments, a nanofiber layer has a water contact angle of less than or equal to 180°, less than or equal to 175°, less than or equal to 150°, less than or equal to 135°, less than or equal to 120°, less than or equal to 110°, less than or equal to 100°, less than or equal to 90°, less than or equal to 80°, less than or equal to 70°, less than or equal to 60°, or less than or equal to 50°. Combinations of the above-referenced ranges are also possible (e.g., greater than or equal to 45° and less than or equal to 180°, greater than or equal to 45° and less than or equal to 135°, greater than or equal to 45° and less than or equal to 120°, or greater than or equal to 50° and less than or equal to)120°. Other ranges are also possible. The contact angle of a nanofiber layer may be determined by in accordance with ASTM D5946 (2009). In embodiments in which more than one nanofiber layer is present, each nanofiber layer may independently have a water contact angle in one or more of the ranges described above.

As described above, in some embodiments a filter media comprises a backer layer. The backer layer may support another layer present in the filter media (e.g., a nanofiber layer) and/or may be a layer onto which another layer was deposited during fabrication of the filter media. For example, in some embodiments, a filter media may comprise a backer layer onto which a nanofiber layer was deposited. The backer layer may provide structural support and/or enhance the ease with which the filter media may be fabricated without appreciably increasing the resistance of the filter media. In some embodiments, the backer layer does not contribute appreciably to the filtration performance of the filter media. In other embodiments, the backer layer may enhance the performance of the filter media in one or more ways (e.g., it may serve as a prefilter layer). In some embodiments, a filter media comprises two or more backer layers. For instance, a filter media may comprise two or more backer layers disposed on one another that together form a composite backer layer. It should be understood that any individual backer layer (and/or composite backer layer) may independently have some or all of the properties described below with respect to backer layers. It should also be understood that a filter media may comprise two backer layers that are identical and/or may comprise two or more backer layers that differ in one or more ways.

When present, a backer layer typically comprises a non-woven fiber web comprising a plurality of fibers. A variety of suitable types of non-woven fiber webs may be employed as backer layers in the filter media described herein. For instance, a filter media may comprise a backer layer comprising a wetlaid non-woven fiber web, a non-wetlaid non-woven fiber web (such as, e.g., a meltblown non-woven fiber web, a carded non-woven fiber web, a spunbond non-woven fiber web), an electrospun non-woven fiber web, and/or another type of non-woven fiber web. In embodiments in which more than one backer layer is present, each backer layer may independently be of one or more of the types described above.

In some embodiments, a backer layer may be compressed. For instance, a filter media may comprise a backer layer that has been calendered, such as a calendered meltblown layer, a calendered carded layer, a calendered spunbond layer, and/or a calendered wetlaid layer.

Calendering may involve, for example, compressing one or more layers using calender rolls under a particular linear pressure, temperature, and line speed. For instance, the linear pressure may be between 50 lb/inch and 400 lb/inch (e.g., between 200 lb/inch and 400 lb/inch, between 50 lb/inch and 200 lb/inch, or between 75 lb/inch and 300 lb/inch); the temperature may be between 75° F. and 400° F. (e.g., between 75° F. and 300° F., between 200° F. and 350° F., or between 275° F. and 390° F.); and the line speed may be between 5 ft/min and 100 ft/min (e.g., between 5 ft/min and 80 ft/min, between 10 ft/min and 50 ft/min, between 15 ft/min and 100 ft/min, or between 20 ft/min and 90 ft/min). Other ranges for linear pressure, temperature and line speed are also possible. In embodiments in which more than one backer layer is present, each backer layer may independently be compressed at a linear pressure, temperature, and/or line speed in one or more of the ranges described above.

When present, a backer layer may comprise a plurality of fibers comprising a variety of suitable types of fibers. In some embodiments, a backer layer comprises a plurality of fibers comprising natural fibers (e.g., cellulose fibers). In some embodiments, a backer layer comprises a plurality of fibers comprising synthetic fibers. The synthetic fibers, if present, may include monocomponent synthetic fibers and/or multicomponent synthetic fibers (e.g., bicomponent synthetic fibers). Non-limiting examples of suitable synthetic fibers include polyolefin fibers (e.g., propylene fibers), polyester fibers (e.g., poly(butylene terephthalate) fibers, poly(ethylene terephthalate) fibers), Nylon fibers, polyaramide fibers, poly(vinyl alcohol) fibers, poly(ether sulfone) fibers, polyacrylic fibers (e.g., poly(acrylonitrile) fibers), fluorinated polymer fibers (e.g., poly(vinylidene difluoride) fibers), and cellulose acetate fibers. In some embodiments, a backer layer comprises a plurality of fibers comprising glass fibers. The backer layer may include more than one type of fiber (e.g., both glass fibers and synthetic fibers) or may include exclusively one type of fiber (e.g., exclusively synthetic fibers of multiple sub-types, such as both polyolefin fibers and polyester fibers; or exclusively polypropylene fibers). In some embodiments, the plurality of fibers in the backer layer comprises fibers comprising a blend of two or more of the polymers listed above (e.g., a blend of a Nylon and a polyester). In embodiments in which more than one backer layer is present, each backer layer may independently comprise fibers comprising one or more of the types of fibers described above.

When a backer layer comprises a plurality of fibers comprising cellulose fibers, the cellulose fibers therein may have a variety of suitable average diameters. In some embodiments, a backer layer comprises cellulose fibers having an average diameter of greater than or equal to 5 microns, greater than or equal to 7 microns, greater than or equal to 10 microns, greater than or equal to 12.5 microns, greater than or equal to 15 microns, greater than or equal to 20 microns, greater than or equal to 25 microns, greater than or equal to 30 microns, greater than or equal to 35 microns, greater than or equal to 40 microns, or greater than or equal to 45 microns. In some embodiments, a backer layer comprises cellulose fibers having an average diameter of less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 12.5 microns, less than or equal to 10 microns, or less than or equal to 7 microns. Combinations of the above-referenced ranges are also possible (e.g., greater than or equal to 5 microns and less than or equal to 50 microns, greater than or equal to 7 microns and less than or equal to 30 microns, or greater than or equal to 10 microns and less than or equal to 20 microns). Other ranges are also possible. In embodiments in which more than one backer layer comprising cellulose fibers is present, each backer layer comprising cellulose fibers may independently comprise cellulose fibers having an average diameter in one or more of the ranges described above.

When a backer layer comprises a plurality of fibers comprising synthetic fibers, the synthetic fibers therein may have a variety of suitable average diameters. In some embodiments, a backer layer comprises synthetic fibers having an average diameter of greater than or equal to 0.05 microns, greater than or equal to 0.075 microns, greater than or equal to 0.1 micron, greater than or equal to 0.125 microns, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 20 microns, greater than or equal to 25 microns, greater than or equal to 30 microns, greater than or equal to 35 microns, greater than or equal to 40 microns, or greater than or equal to 45 microns. In some embodiments, a backer layer comprises synthetic fibers having an average diameter of less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 12.5 microns, less than or equal to 10 microns, less than or equal to 7.5 microns, less than or equal to 5 microns, less than or equal to 4 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.75 microns, less than or equal to 0.5 microns, less than or equal to 0.4 microns, less than or equal to 0.3 microns, less than or equal to 0.25 microns, less than or equal to 0.2 microns, less than or equal to 0.15 microns, less than or equal to 0.125 microns, less than or equal to 0.1 micron, or less than or equal to 0.075 microns. Combinations of the above-referenced ranges are also possible (e.g., greater than or equal to 0.05 microns and less than or equal to 50 microns, greater than or equal to 0.05 microns and less than or equal to 30 microns, greater than or equal to 0.05 microns and less than or equal to 5 microns, greater than or equal to 0.05 microns and less than or equal to 2 microns, greater than or equal to 0.075 microns and less than or equal to 0.5 microns, greater than or equal to 0.15 microns and less than or equal to 3 microns, greater than or equal to 0.25 microns and less than or equal to 3 microns, or greater than or equal to 0.25 microns and less than or equal to 2 microns). Other ranges are also possible. In embodiments in which more than one backer layer comprising synthetic fibers is present, each backer layer comprising synthetic fibers may independently comprise synthetic fibers having an average diameter in one or more of the ranges described above.

When a backer layer comprises a plurality of fibers comprising glass fibers, the glass fibers therein may have a variety of suitable average diameters. In some embodiments, a backer layer comprises glass fibers having an average diameter of greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 7.5 microns, greater than or equal to 10 microns, or greater than or equal to 12.5 microns. In some embodiments, a backer layer comprises glass fibers having an average diameter of less than or equal to 15 microns, less than or equal to 12.5 microns, less than or equal to 10 microns, less than or equal to 7.5 microns, less than or equal to 5 microns, less than or equal to 4 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.75 microns, less than or equal to 0.5 microns, less than or equal to 0.4 microns, less than or equal to 0.3 microns, less than or equal to 0.25 microns, or less than or equal to 0.2 microns. Combinations of the above-referenced ranges are also possible (e.g., greater than or equal to 0.15 microns and less than or equal to 15 microns, greater than or equal to 0.15 microns and less than or equal to 3 microns, greater than or equal to 0.25 microns and less than or equal to 3 microns, or greater than or equal to 0.25 microns and less than or equal to 2 microns). Other ranges are also possible. In embodiments in which more than one backer layer comprising glass fibers is present, each backer layer comprising glass fibers may independently comprise glass fibers having an average diameter in one or more of the ranges described above.

The fibers in a plurality of fibers in a backer layer, if present, may have a variety of suitable average lengths. In some embodiments, the average length of the fibers in a backer layer is greater than or equal to 0.3 mm, greater than or equal to 0.4 mm, greater than or equal to 0.5 mm, greater than or equal to 0.75 mm, greater than or equal to 1 mm, greater than or equal to 1.25 mm, greater than or equal to 1.5 mm, greater than or equal to 2 mm, greater than or equal to 3 mm, greater than or equal to 4 mm, greater than or equal to 5 mm, greater than or equal to 7.5 mm, greater than or equal to 10 mm, greater than or equal to 12.5 mm, greater than or equal to 15 mm, greater than or equal to 20 mm, greater than or equal to 25 mm, greater than or equal to 30 mm, greater than or equal to 40 mm, greater than or equal to 50 mm, or greater than or equal to 75 mm. In some embodiments, the average length of the fibers in a backer layer is less than or equal to 100 mm, less than or equal to 75 mm, less than or equal to 50 mm, less than or equal to 40 mm, less than or equal to 30 mm, less than or equal to 25 mm, less than or equal to 20 mm, less than or equal to 15 mm, less than or equal to 12.5 mm, less than or equal to 10 mm, less than or equal to 7.5 mm, less than or equal to 5 mm, less than or equal to 4 mm, less than or equal to 3 mm, less than or equal to 2.5 mm, less than or equal to 2 mm, less than or equal to 1.5 mm, less than or equal to 1.25 mm, less than or equal to 1 mm, less than or equal to 0.75 mm, less than or equal to 0.5 mm, or less than or equal to 0.4 mm. Combinations of the above-referenced ranges are also possible (e.g., greater than or equal to 0.3 mm and less than or equal to 100 mm, or greater than or equal to 1 mm and less than or equal to 50 mm). Other ranges are also possible. In embodiments in which more than one backer layer is present, each backer layer may independently comprise fibers having an average length in one or more of the ranges described above.

In some embodiments, the backer layer comprises continuous fibers, which may have a variety of suitable lengths. For instance, the average length of the fibers in a backer layer may be greater than or equal to 100 mm, greater than or equal to 125 mm, greater than or equal to 150 mm, greater than or equal to 200 mm, greater than or equal to 250 mm, greater than or equal to 300 mm, greater than or equal to 400 mm, greater than or equal to 500 mm, greater than or equal to 750 mm, greater than or equal to 1 m, greater than or equal to 1.25 m, greater than or equal to 1.5 m, greater than or equal to 2 m, greater than or equal to 2.5 m, greater than or equal to 3 m, greater than or equal to 4 m, greater than or equal to 5 m, greater than or equal to 7.5 m, greater than or equal to 10 m, greater than or equal to 12.5 m, greater than or equal to 15 m, greater than or equal to 20 m, greater than or equal to 25 m, greater than or equal to 30 m, greater than or equal to 40 m, greater than or equal to 50 m, greater than or equal to 75 m, greater than or equal to 100 m, greater than or equal to 125 m, greater than or equal to 150 m, greater than or equal to 200 m, greater than or equal to 250 m, greater than or equal to 300 m, greater than or equal to 400 m, greater than or equal to 500 m, or greater than or equal to 750 m. In some embodiments, the average length of the fibers in a backer layer is less than or equal to 1 km, less than or equal to 750 m, less than or equal to 500 m, less than or equal to 400 m, less than or equal to 300 m, less than or equal to 250 m, less than or equal to 200 m, less than or equal to 150 m, less than or equal to 125 m, less than or equal to 100 m, less than or equal to 75 m, less than or equal to 50 m, less than or equal to 40 m, less than or equal to 30 m, less than or equal to 25 m, less than or equal to 20 m, less than or equal to 15 m, less than or equal to 12.5 m, less than or equal to 10 m, less than or equal to 7.5 m, less than or equal to 5 m, less than or equal to 4 m, less than or equal to 3 m, less than or equal to 2.5 m, less than or equal to 2 m, less than or equal to 1.5 m, less than or equal to 1.25 m, less than or equal to 1 m, less than or equal to 750 mm, less than or equal to 500 mm, less than or equal to 400 mm, less than or equal to 300 mm, less than or equal to 250 mm, less than or equal to 200 mm, less than or equal to 150 mm, or less than or equal to 125 mm. Combinations of the above-referenced ranges are also possible (e.g., greater than or equal to 125 mm and less than or equal to 1 km, greater than or equal to 125 mm and less than or equal to 2 m). Other ranges are also possible. In embodiments in which more than one backer layer is present, each backer layer may independently comprise fibers having an average length in one or more of the ranges described above.

Some backer layers include components other than fibers. For instance, a backer layer may comprise a binder resin. The binder resin may make up less than or equal to 30 wt %, less than or equal to 25 wt %, less than or equal to 20 wt %, less than or equal to 15 wt %, less than or equal to 12.5 wt %, less than or equal to 10 wt %, less than or equal to 7.5 wt %, less than or equal to 5 wt %, less than or equal to 4 wt %, less than or equal to 3 wt %, less than or equal to 2.5 wt %, less than or equal to 2 wt %, less than or equal to 1.5 wt %, less than or equal to 1.25 wt %, less than or equal to 1 wt %, less than or equal to 0.75 wt %, less than or equal to 0.5 wt %, less than or equal to 0.4 wt %, less than or equal to 0.3 wt %, less than or equal to 0.25 wt %, less than or equal to 0.2 wt %, less than or equal to 0.15 wt %, less than or equal to 0.125 wt %, or less than or equal to 0.1 wt % of the backer layer. The binder resin may make up greater than or equal to 0 wt %, greater than or equal to 0.1 wt %, greater than or equal to 0.125 wt %, greater than or equal to 0.15 wt %, greater than or equal to 0.2 wt %, greater than or equal to 0.25 wt %, greater than or equal to 0.3 wt %, greater than or equal to 0.4 wt %, greater than or equal to 0.5 wt %, greater than or equal to 0.75 wt %, greater than or equal to 1 wt %, greater than or equal to 1.25 wt %, greater than or equal to 1.5 wt %, greater than or equal to 2 wt %, greater than or equal to 2.5 wt %, greater than or equal to 3 wt %, greater than or equal to 4 wt %, greater than or equal to 5 wt %, greater than or equal to 7.5 wt %, greater than or equal to 10 wt %, greater than or equal to 12.5 wt %, greater than or equal to 15 wt %, greater than or equal to 20 wt %, or greater than or equal to 25 wt % of the backer layer. Combinations of the above-referenced ranges are also possible (e.g., less than or equal to 30 wt % of the backer layer). Other ranges are also possible. In some embodiments, the backer layer is binder-free (i.e., binder resin makes up 0 wt % of the backer layer). In embodiments in which more than one backer layer is present, each backer layer may independently comprise a binder resin in an amount in one or more of the ranges described above.

When present, a backer layer may have a variety of suitable solidities. In some embodiments, a backer layer has a solidity of greater than or equal to 4%, greater than or equal to 5%, greater than or equal to 7.5%, greater than or equal to 10%, greater than or equal to 15%, greater than or equal to 20%, greater than or equal to 25%, greater than or equal to 30%, greater than or equal to 35%, greater than or equal to 40%, or greater than or equal to 45%. In some embodiments, a backer layer has a solidity of less than or equal to 50%, less than or equal to 45%, less than or equal to 40%, less than or equal to 35%, less than or equal to 30%, less than or equal to 25%, less than or equal to 20%, less than or equal to 15%, less than or equal to 10%, less than or equal to 7.5%, or less than or equal to 5%. Combinations of the above-referenced ranges are also possible (e.g., greater than or equal to 4% and less than or equal to 50%, greater than or equal to 5% and less than or equal to 40%, or greater than or equal to 5% and less than or equal to 35%). Other ranges are also possible. In embodiments in which more than one backer layer is present, each backer layer may independently have a solidity in one or more of the ranges described above.

The solidity of a backer layer is equivalent to the percentage of the backer layer occupied by solid material. One non-limiting way of determining solidity of the backer layer is described in this paragraph, but other methods are also possible. The method described in this paragraph includes determining the basis weight and thickness of the backer layer and then applying the following formula: solidity=[basis weight/(fiber density*thickness)]*100%. The fiber density is equivalent to the average density of the material or material(s) forming the fiber, which is typically specified by the fiber manufacturer. The average density of the materials forming the fibers may be determined by: (1) determining the total volume of all of the fibers in the backer layer; and (2) dividing the total mass of all of the fibers in the backer layer by the total volume of all of the fibers in the backer layer. If the mass and density of each type of fiber in the backer layer are known, the volume of all the fibers in the backer layer may be determined by: (1) for each type of fiber, dividing the total mass of the type of fiber in the backer layer by the density of the type of fiber; and (2) summing the volumes of each fiber type. If the mass and density of each type of fiber in the backer layer are not known, the volume of all the fibers in the backer layer may be determined in accordance with Archimedes' principle. In embodiments in which more than one backer layer is present, each backer layer may independently have a solidity in one or more of the ranges described above.

When present, a backer layer may have a variety of suitable basis weights. In some embodiments, a backer layer has a basis weight of greater than or equal to 15 g/m², greater than or equal to 17.5 g/m², greater than or equal to 20 g/m², greater than or equal to 25 g/m², greater than or equal to 30 g/m², greater than or equal to 40 g/m², greater than or equal to 50 g/m², greater than or equal to 75 g/m², greater than or equal to 100 g/m², greater than or equal to 150 g/m², greater than or equal to 200 g/m², greater than or equal to 250 g/m², greater than or equal to 300 g/m², or greater than or equal to 400 g/m². In some embodiments, a backer layer has a basis weight of less than or equal to 500 g/m², less than or equal to 400 g/m², less than or equal to 300 g/m², less than or equal to 250 g/m², less than or equal to 200 g/m², less than or equal to 150 g/m², less than or equal to 100 g/m², less than or equal to 75 g/m², less than or equal to 50 g/m², less than or equal to 40 g/m², less than or equal to 30 g/m², less than or equal to 25 g/m², less than or equal to 20 g/m², or less than or equal to 17.5 g/m². Combinations of the above-referenced ranges are also possible (e.g., greater than or equal to 15 g/m² and less than or equal to 500 g/m², greater than or equal to 20 g/m² and less than or equal to 300 g/m², or greater than or equal to 30 g/m² and less than or equal to 200 g/m²). Other ranges of basis weight are also possible. The basis weight of a backer layer may be determined in accordance with ISO 536:2012. In embodiments in which more than one backer layer is present, each backer layer may independently have a basis weight in one or more of the ranges described above.

When present, a backer layer may have a variety of suitable specific surface areas. In some embodiments, a backer layer has a specific surface area of greater than or equal to 0 m²/g, greater than or equal to 0.1 m²/g, greater than or equal to 0.2 m²/g, greater than or equal to 0.5 m²/g, greater than or equal to 1 m²/g, greater than or equal to 2 m²/g, greater than or equal to 5 m²/g, greater than or equal to 10 m²/g, greater than or equal to 15 m²/g, greater than or equal to 20 m²/g, greater than or equal to 25 m²/g, greater than or equal to 30 m²/g, greater than or equal to 35 m²/g, greater than or equal to 40 m²/g, or greater than or equal to 45 m²/g. In some embodiments, a backer layer has a specific surface area of less than or equal to 50 m²/g, less than or equal to 45 m²/g, less than or equal to 40 m²/g, less than or equal to 35 m²/g, less than or equal to 30 m²/g, less than or equal to 25 m²/g, less than or equal to 20 m²/g, less than or equal to 15 m²/g, less than or equal to 10 m²/g, less than or equal to 5 m²/g, less than or equal to 2 m²/g, less than or equal to 1 m²/g, less than or equal to 0.5 m²/g, less than or equal to 0.2 m²/g, or less than or equal to 0.1 m²/g. Combinations of the above-referenced ranges are also possible (e.g., greater than or equal to 0 m²/g and less than or equal to 50 m²/g, greater than or equal to 0 m²/g and less than or equal to 40 m²/g, or greater than or equal to 0 m²/g and less than or equal to 35 m²/g). Other ranges are also possible. The specific surface area of a backer layer may be determined in accordance with section 10 of Battery Council International Standard BCIS-03A (2009), “Recommended Battery Materials Specifications Valve Regulated Recombinant Batteries”, section 10 being “Standard Test Method for Surface Area of Recombinant Battery Separator Mat”. Following this technique, the specific surface area is measured via adsorption analysis using a BET surface analyzer (e.g., Micromeritics Gemini III 2375 Surface Area Analyzer) with nitrogen gas; the sample amount is between 0.5 and 0.6 grams in a 3/4″ tube; and, the sample is allowed to degas at 100° C. for a minimum of 3 hours. In embodiments in which more than one backer layer is present, each backer layer may independently have a specific surface area in one or more of the ranges described above.

When present, a backer layer may have a variety of suitable mean flow pore sizes. In some embodiments, a backer layer has a mean flow pore size of greater than or equal to 0.1 micron, greater than or equal to 0.125 microns, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 20 microns, greater than or equal to 25 microns, greater than or equal to 30 microns, greater than or equal to 35 microns, greater than or equal to 40 microns, greater than or equal to 45 microns, greater than or equal to 50 microns, greater than or equal to 75 microns, greater than or equal to 100 microns, greater than or equal to 125 microns, greater than or equal to 150 microns, or greater than or equal to 200 microns. In some embodiments, a backer layer has a mean flow pore size of less than or equal to 250 microns, less than or equal to 200 microns, less than or equal to 150 microns, less than or equal to 125 microns, less than or equal to 100 microns, less than or equal to 75 microns, less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 12.5 microns, less than or equal to 10 microns, less than or equal to 7.5 microns, less than or equal to 5 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.75 microns, less than or equal to 0.5 microns, less than or equal to 0.4 microns, less than or equal to 0.3 microns, less than or equal to 0.2 microns, less than or equal to 0.15 microns, or less than or equal to 0.125 microns. Combinations of the above-referenced ranges are also possible (e.g., greater than or equal to 0.1 micron and less than or equal to 250 microns, greater than or equal to 0.1 micron and less than or equal to 50 microns, greater than or equal to 0.2 microns and less than or equal to 35 microns, or greater than or equal to 0.2 microns and less than or equal to 30 microns). Other ranges are also possible. The mean flow pore size of a backer layer may be determined in accordance with ASTM F316 (2003). In embodiments in which more than one backer layer is present, each backer layer may independently have a mean flow pore size in one or more of the ranges described above.

When present, a backer layer may have a variety of suitable maximum pore sizes. In some embodiments, a backer layer has a maximum pore size of greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 20 microns, greater than or equal to 25 microns, greater than or equal to 30 microns, greater than or equal to 35 microns, greater than or equal to 40 microns, greater than or equal to 45 microns, greater than or equal to 50 microns, greater than or equal to 75 microns, greater than or equal to 100 microns, greater than or equal to 125 microns, greater than or equal to 150 microns, greater than or equal to 200 microns, greater than or equal to 250 microns, greater than or equal to 300 microns, greater than or equal to 400 microns, or greater than or equal to 500 microns. In some embodiments, a backer layer has a maximum pore size of less than or equal to 750 microns, less than or equal to 500 microns, less than or equal to 400 microns, less than or equal to 300 microns, less than or equal to 250 microns, less than or equal to 200 microns, less than or equal to 150 microns, less than or equal to 125 microns, less than or equal to 100 microns, less than or equal to 75 microns, less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 12.5 microns, less than or equal to 10 microns, less than or equal to 7.5 microns, less than or equal to 5 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.75 microns, less than or equal to 0.5 microns, less than or equal to 0.4 microns, less than or equal to 0.3 microns, or less than or equal to 0.25 microns. Combinations of the above-referenced ranges are also possible (e.g., greater than or equal to 0.2 microns and less than or equal to 750 microns, greater than or equal to 0.2 microns and less than or equal to 50 microns, greater than or equal to 0.2 microns and less than or equal to 40 microns, or greater than or equal to 0.3 microns and less than or equal to 30 microns). Other ranges are also possible. The maximum pore size of a backer layer may be determined in accordance with ASTM F316 (2003). In embodiments in which more than one backer layer is present, each backer layer may independently have a maximum pore size in one or more of the ranges described above.

When present, a backer layer may have a variety of suitable ratios of maximum pore size to mean flow pore size. In some embodiments, a backer layer has a ratio of maximum pore size to mean flow pore size of greater than or equal to 1.3, greater than or equal to 1.5, greater than or equal to 1.75, greater than or equal to 2, greater than or equal to 2.5, greater than or equal to 3, greater than or equal to 4, greater than or equal to 5, greater than or equal to 7.5, greater than or equal to 10, greater than or equal to 12.5, greater than or equal to 15, greater than or equal to 20, or greater than or equal to 25. In some embodiments, a backer layer has a ratio of maximum pore size to mean flow pore size of less than or equal to 30, less than or equal to 25, less than or equal to 20, less than or equal to 15, less than or equal to 12.5, less than or equal to 10, less than or equal to 7.5, less than or equal to 5, less than or equal to 4, less than or equal to 3, less than or equal to 2.5, less than or equal to 2, less than or equal to 1.75, or less than or equal to 1.5. Combinations of the above-referenced ranges are also possible (e.g., greater than or equal to 1.3 and less than or equal to 30, greater than or equal to 1.3 and less than or equal to 25, or greater than or equal to 1.3 and less than or equal to 20). Other ranges are also possible. The ratio of maximum pore size to mean flow pore size of a backer layer may be determined by finding the maximum pore size and mean flow pore size in accordance with ASTM F316 (2003) and then dividing the maximum pore size by the mean flow pore size. In embodiments in which more than one backer layer is present, each backer layer may independently have a ratio of maximum pore size to mean flow pore size in one or more of the ranges described above.

When present, a backer layer may have a variety of suitable air permeabilities. In some embodiments, a backer layer has an air permeability of greater than or equal to 0.5 CFM, greater than or equal to 0.75 CFM, greater than or equal to 1 CFM, greater than or equal to 1.25 CFM, greater than or equal to 1.5 CFM, greater than or equal to 2 CFM, greater than or equal to 2.5 CFM, greater than or equal to 3 CFM, greater than or equal to 4 CFM, greater than or equal to 5 CFM, greater than or equal to 7.5 CFM, greater than or equal to 10 CFM, greater than or equal to 12.5 CFM, greater than or equal to 15 CFM, greater than or equal to 20 CFM, greater than or equal to 25 CFM, greater than or equal to 30 CFM, greater than or equal to 40 CFM, greater than or equal to 50 CFM, greater than or equal to 75 CFM, greater than or equal to 100 CFM, greater than or equal to 125 CFM, greater than or equal to 150 CFM, greater than or equal to 200 CFM, greater than or equal to 250 CFM, greater than or equal to 300 CFM, greater than or equal to 400 CFM, greater than or equal to 500 CFM, greater than or equal to 750 CFM, greater than or equal to 1000 CFM, greater than or equal to 1250 CFM, or greater than or equal to 1500 CFM. In some embodiments, a backer layer has an air permeability of less than or equal to 2000 CFM, less than or equal to 1500 CFM, less than or equal to 1250 CFM, less than or equal to 1000

CFM, less than or equal to 750 CFM, less than or equal to 500 CFM, less than or equal to 400 CFM, less than or equal to 300 CFM, less than or equal to 250 CFM, less than or equal to 200 CFM, less than or equal to 150 CFM, less than or equal to 125 CFM, less than or equal to 100 CFM, less than or equal to 75 CFM, less than or equal to 50 CFM, less than or equal to 40 CFM, less than or equal to 30 CFM, less than or equal to 25 CFM, less than or equal to 20 CFM, less than or equal to 15 CFM, less than or equal to 12.5 CFM, less than or equal to 10 CFM, less than or equal to 7.5 CFM, less than or equal to 5 CFM, less than or equal to 4 CFM, less than or equal to 3 CFM, less than or equal to 2.5 CFM, less than or equal to 2 CFM, less than or equal to 1.5 CFM, less than or equal to 1.25 CFM, less than or equal to 1 CFM, or less than or equal to 0.75 CFM. Combinations of the above-referenced ranges are also possible (e.g., greater than or equal to 0.5 CFM and less than or equal to 2000 CFM, greater than or equal to 0.5 CFM and less than or equal to 400 CFM, greater than or equal to 0.5 CFM and less than or equal to 200 CFM, greater than or equal to 1 CFM and less than or equal to 150 CFM, or greater than or equal to 1 CFM and less than or equal to 100 CFM). Other ranges are also possible. The air permeability of a backer layer may be determined in accordance with ASTM Test Standard D737-04 (2016) at a pressure of 125 Pa. In embodiments in which more than one backer layer is present, each backer layer may independently have an air permeability in one or more of the ranges described above.

As described above, in some embodiments a filter media comprises an additional layer. The additional layer may be provided in addition to a nanofiber layer and/or a backer layer. Non-limiting examples of suitable additional layers include prefilter layers and protective layers.

In some embodiments, the additional layer is a scrim (e.g., a prefilter layer that is also a scrim, a protective layer that is also a scrim). The additional layer may be a non-woven fiber web, such as a meltblown or spunbond non-woven fiber web. The additional layer may be attached to another layer in the fiber web (e.g., a nanofiber layer, a backer layer, another additional layer) in a variety of suitable manners, such as with an adhesive, by use of a calender, and/or by ultrasonic bonding.

When present, an additional layer may have a wide variety of properties. Additional layers typically have a low resistance to fluid flow and/or are lightweight (e.g., having a basis weight less than or equal to 100 g/m²). In some embodiments, the additional layer does not contribute appreciably to the filtration performance of the filter media. In other embodiments, the additional layer does contribute to one or more properties of the filter media. For instance, the additional layer may serve as a prefilter layer. As another example, a relatively large percentage of the total pressure drop across the filter media may occur across the additional layer. This may be beneficial when one or more other layers in the filter media, such as one or more nanofiber layers, are relatively fragile and/or may not be able to withstand a large pressure drop.

In some embodiments, a filter media described herein has a relatively high value of gamma at the most penetrating particle size (MPPS). Gamma is defined by the following formula: Gamma=(−log₁₀(MPPS penetration %/100)/pressure drop, mm H₂O)×100. Penetration, often expressed as a percentage, is defined as follows: Pen (%)=(C/C₀)*100 where C is the particle concentration after passage through the filter and Co is the particle concentration before passage through the filter. MPPS penetration is the penetration of the most penetrating particle size; in other words, when penetration is measured for a range of particle sizes, the MPPS penetration is the value of penetration measured for the particle with the highest penetration.

MPPS penetration and pressure drop can be measured using the EN1822:2009 standard for air filtration, which are described below. Penetration may be measured by blowing dioctyl phthalate (DOP) particles through a filter media and measuring the percentage of particles that penetrate therethrough. This may be accomplished by use of a TSI 3160 automated filter testing unit from TSI, Inc. equipped with a dioctyl phthalate generator for DOP aerosol testing based on the EN1822:2009 standard for MPPS DOP particles. The TSI 3160 automated filter testing unit may be employed to sequentially blow populations of DOP particles with varying average particle diameters at a 100 cm² face area of the upstream face of the filter media. The populations of particles may be blown at the upstream face of the filter media in order of increasing average diameter, may each have a geometric standard deviation of less than 1.3, and may have the following set of average diameters: 0.04 microns, 0.08 microns, 0.12 microns, 0.16 microns, 0.2 microns, 0.26 microns and 0.3 microns. The upstream particle and downstream concentrations may be measured by use of condensation particle counters. During the penetration measurement, the 100 cm² face area of the upstream face of the filter media may be subject to a continuous loading of DOP particles at an airflow of 12 L/min, giving a media face velocity of 2 cm/s. Each population of particles may be blown at the upstream face of the filter media for 120 s or such that at least 1000 particles are counted downstream of the filter media, whichever is longer.

In some embodiments, a filter media has a gamma at the MPPS of greater than or equal to 4, greater than or equal to 5, greater than or equal to 6, greater than or equal to 8, greater than or equal to 10, greater than or equal to 12, greater than or equal to 15, greater than or equal to 17, greater than or equal to 20, greater than or equal to 25, greater than or equal to 30, greater than or equal to 35, greater than or equal to 40, greater than or equal to 50, greater than or equal to 55, greater than or equal to 60, or greater than or equal to 65. In some embodiments, a filter media has a gamma at the MPPS of less than or equal to 70, less than or equal to 65, less than or equal to 60, less than or equal to 55, less than or equal to 50, less than or equal to 45, less than or equal to 40, less than or equal to 35, less than or equal to 30, less than or equal to 25, less than or equal to 20, less than or equal to 15, less than or equal to 10, less than or equal to 8, less than or equal to 6, or less than or equal to 5. Combinations of the above-referenced ranges are also possible (e.g., greater than or equal to 4 and less than or equal to 70, greater than or equal to 10 and less than or equal to 55, or greater than or equal to 30 and less than or equal to 55). Other ranges are also possible.

In some embodiments, a filter media is a high efficiency particulate air (HEPA) or ultra-low particulate air (ULPA) filter. These filters are required to remove particulates at an efficiency level specified by EN1822:2009. In some embodiments, the filter media removes particulates at an efficiency of greater than 99.95% (H 13), greater than 99.995% (H 14), greater than 99.9995% (U 15), greater than 99.99995% (U 16), or greater than 99.999995% (U 17).

In some embodiments, a filter media, such as a filter media suitable for air filtration, has a relatively high dust holding capacity. In some embodiments, a filter media has a dust holding capacity of greater than or equal to 2 g/m², greater than or equal to 2.5 g/m², greater than or equal to 3 g/m², greater than or equal to 4 g/m², greater than or equal to 5 g/m², greater than or equal to 7.5 g/m², greater than or equal to 10 g/m², greater than or equal to 12.5 g/m², greater than or equal to 15 g/m², greater than or equal to 20 g/m², greater than or equal to 25 g/m², greater than or equal to 30 g/m², greater than or equal to 40 g/m², greater than or equal to 50 g/m², greater than or equal to 75 g/m², greater than or equal to 100 g/m², greater than or equal to 125 g/m², greater than or equal to 150 g/m², greater than or equal to 200 g/m², greater than or equal to 250 g/m², greater than or equal to 300 g/m², greater than or equal to 400 g/m², greater than or equal to 500 g/m², or greater than or equal to 750 g/m². In some embodiments, a filter media has a dust holding capacity of less than or equal to 1000 g/m², less than or equal to 750 g/m², less than or equal to 500 g/m², less than or equal to 400 g/m², less than or equal to 300 g/m², less than or equal to 250 g/m², less than or equal to 200 g/m², less than or equal to 150 g/m², less than or equal to 125 g/m², less than or equal to 100 g/m², less than or equal to 75 g/m², less than or equal to 50 g/m², less than or equal to 40 g/m², less than or equal to 30 g/m², less than or equal to 25 g/m², less than or equal to 20 g/m², less than or equal to 15 g/m², less than or equal to 12.5 g/m2, less than or equal to 10 g/m², less than or equal to 7.5 g/m², less than or equal to 5 g/m², less than or equal to 4 g/m², less than or equal to 3 g/m², or less than or equal to 2.5 g/m². Combinations of the above-referenced ranges are also possible (e.g., greater than or equal to 2 g/m² and less than or equal to 1000 g/m², greater than or equal to 5 g/m² and less than or equal to 500 g/m², or greater than or equal to 10 g/m² and less than or equal to 200 g/m²). Other ranges are also possible. The dust holding capacity is the difference in the weight of the filter media before exposure to a certain amount of fine dust and the weight of the filter media after the exposure to the fine dust, upon reaching a particular pressure drop across the filter media, divided by the area of the filter media. Dust holding capacity may be determined with the aid of an ANSI/ASHRAE Standard 52.2-2012 flat sheet test rig. A sample of the filter media with a 100 cm² area may be exposed to test dust at a 15 fpm velocity until the pressure drop of the filter media rises to 1.5 inches of H₂O on a column. At this point, the weight of the dust captured may be divided by the area of the filter media to yield the dust holding capacity. The test dust employed may be 72% SAE Standard J726 test dust (fine) as described in ANSI/ASHRAE Standard 52.2-2012.

In some embodiments, a filter media, such as a filter media suitable for fuel filtration, has a relatively high initial beta ratio at 4 microns. The initial beta ratio at 4 microns of a filter media is the ratio of the upstream average particle count (Co) to the downstream average particle count (C) when the filter media is exposed to 4 micron particles. In some embodiments, a filter media has an initial beta ratio at 4 microns of greater than or equal to 20, greater than or equal to 25, greater than or equal to 30, greater than or equal to 40, greater than or equal to 50, greater than or equal to 75, greater than or equal to 100, greater than or equal to 125, greater than or equal to 150, greater than or equal to 200, greater than or equal to 250, greater than or equal to 300, greater than or equal to 400, greater than or equal to 500, greater than or equal to 750, greater than or equal to 1,000, greater than or equal to 1,250, greater than or equal to 1,500, greater than or equal to 2,000, greater than or equal to 2,500, greater than or equal to 3,000, greater than or equal to 4,000, greater than or equal to 5,000, or greater than or equal to 7,500. In some embodiments, a filter media has an initial beta ratio at 4 microns of less than or equal to 10,000, less than or equal to 7,500, less than or equal to 5,000, less than or equal to 4,000, less than or equal to 3,000, less than or equal to 2,500, less than or equal to 2,000, less than or equal to 1,500, less than or equal to 1,250, less than or equal to 1,000, less than or equal to 750, less than or equal to 500, less than or equal to 400, less than or equal to 300, less than or equal to 250, less than or equal to 200, less than or equal to 150, less than or equal to 125, less than or equal to 100, less than or equal to 75, less than or equal to 50, less than or equal to 40, less than or equal to 30, or less than or equal to 25. Combinations of the above-referenced ranges are also possible (e.g., greater than or equal to 20 and less than or equal to 10,000, greater than or equal to 50 and less than or equal to 10,000, or greater than or equal to 100 and less than or equal to 10,000). Other ranges are also possible. The initial beta ratio at 4 microns of a filter media may be determined in accordance with ISO 19438 using ISO medium test dust (A3), where the initial beta ratio at 4 microns is the beta ratio at 4 microns measured at the first time step when the pressure drop is at 5% of the terminal value.

The initial beta ratio may be used to calculate an initial efficiency. An initial efficiency at 4 microns may be calculated from the values in the paragraph above by using the following formula: efficiency =100%*(1-1/(initial beta ratio at 4 microns)). For instance, a filter media having an initial beta ratio at 4 microns of 20 would have an initial efficiency at 4 microns of 95%.

In some embodiments, a filter media, such as a filter media suitable for fuel filtration, has a relatively high initial beta ratio at 1.5 microns. The initial beta ratio at 1.5 microns of a filter media is the ratio of the upstream average particle count (Co) to the downstream average particle count (C) when the filter media is exposed to 1.5 micron particles. In some embodiments, a filter media has an initial beta ratio at 1.5 microns of greater than or equal to 10, greater than or equal to 12.5, greater than or equal to 15, greater than or equal to 20, greater than or equal to 25, greater than or equal to 30, greater than or equal to 40, greater than or equal to 50, greater than or equal to 75, greater than or equal to 100, greater than or equal to 125, greater than or equal to 150, greater than or equal to 200, greater than or equal to 250, greater than or equal to 300, greater than or equal to 400, greater than or equal to 500, greater than or equal to 750, greater than or equal to 1,000, greater than or equal to 1,250, greater than or equal to 1,500, greater than or equal to 2,000, greater than or equal to 2,500, greater than or equal to 3,000, greater than or equal to 4,000, greater than or equal to 5,000, or greater than or equal to 7,500. In some embodiments, a filter media has an initial beta ratio at 1.5 microns of less than or equal to 10,000, less than or equal to 7,500, less than or equal to 5,000, less than or equal to 4,000, less than or equal to 3,000, less than or equal to 2,500, less than or equal to 2,000, less than or equal to 1,500, less than or equal to 1,250, less than or equal to 1,000, less than or equal to 750, less than or equal to 500, less than or equal to 400, less than or equal to 300, less than or equal to 250, less than or equal to 200, less than or equal to 150, less than or equal to 125, less than or equal to 100, less than or equal to 75, less than or equal to 50, less than or equal to 40, less than or equal to 30, less than or equal to 25, less than or equal to 20, less than or equal to 15, or less than or equal to 12.5. Combinations of the above-referenced ranges are also possible (e.g., greater than or equal to 10 and less than or equal to 10,000, greater than or equal to 15 and less than or equal to 10,000, or greater than or equal to 20 and less than or equal to 10,000). Other ranges are also possible. The initial beta ratio at 1.5 microns of a filter media may be determined in accordance with ISO 19438 using ISO fine test dust (A2), where the initial beta ratio at 1.5 microns is the beta ratio at 1.5 microns measured at the first time step when the pressure drop is at 5% of the terminal value.

An initial efficiency at 1.5 microns may be calculated from the values of initial beta ratio at 1.5 microns in the paragraph above by using the following formula: efficiency=100%*(1−1/(initial beta ratio at 1.5 microns)). For instance, a filter media having an initial beta ratio at 1.5 microns of 10 would have an initial efficiency at 1.5 microns of 90%.

In some embodiments, a filter media, such as a filter media suitable for fuel filtration, has a relatively high average fuel-water separation efficiency. In some embodiments, a filter media has an average fuel-water separation efficiency of greater than or equal to 40%, greater than or equal to 45%, greater than or equal to 50%, greater than or equal to 55%, greater than or equal to 60%, greater than or equal to 65%, greater than or equal to 70%, greater than or equal to 75%, greater than or equal to 80%, greater than or equal to 85%, greater than or equal to 90%, or greater than or equal to 95%. In some embodiments, a filter media has an average fuel-water separation efficiency of less than or equal to 100%, less than or equal to 95%, less than or equal to 90%, less than or equal to 85%, less than or equal to 80%, less than or equal to 75%, less than or equal to 70%, less than or equal to 65%, less than or equal to 60%, less than or equal to 55%, less than or equal to 50%, or less than or equal to 45%. Combinations of the above-referenced ranges are also possible (e.g., greater than or equal to 40% and less than or equal to 100%, greater than or equal to 50% and less than or equal to 100%, or greater than or equal to 60% and less than or equal to 100%). Other ranges are also possible.

The average fuel-water separation efficiency of a filter media may be measured in accordance with the SAEJ1488 test. The test involves sending a sample of fuel (ultra-low sulfur diesel fuel) with controlled water content (2500 ppm) through a pump across the media at a face velocity of 0.069 cm/sec. The water is emulsified into fine droplets and sent to challenge the media. The water is coalesced, shed, or both coalesced and shed, and collects at the bottom of the housing. The water content of the sample is measured both upstream and downstream of the media, via Karl Fischer titration. The fuel-water separation efficiency is the amount of water removed from the fuel-water mixture, and is equivalent to (1-C/2500)*100%, where C is the downstream concentration of water. The average efficiency is the average of the efficiencies measured during a 150 minute test. The first measurement of the sample upstream and downstream of the media is taken at 10 minutes from the start of the test. Then, measurement of the sample downstream of the media is taken every 20 minutes until 150 minutes have elapsed from the beginning of the test.

In some embodiments, a filter media described herein is capable of filtering contaminants from fuel for an appreciable period of time. In some embodiments, a filter media has an average lifetime of greater than or equal to 3 minutes, greater than or equal to 6 minutes, greater than or equal to 10 minutes, greater than or equal to 20 minutes, greater than or equal to 40 minutes, greater than or equal to 55 minutes, greater than or equal to 60 minutes, greater than or equal to 70 minutes, greater than or equal to 85 minutes, greater than or equal to 100 minutes, greater than or equal to 125 minutes, greater than or equal to 150 minutes, greater than or equal to 175 minutes, greater than or equal to 200 minutes, or greater than or equal to 225 minutes. In some embodiments, a filter media may has an average lifetime of less than or equal to 250 minutes, less than or equal to 225 minutes, less than or equal to 200 minutes, less than or equal to 175 minutes, less than or equal to 160 minutes, less than or equal to 130 minutes, less than or equal to 110 minutes, less than or equal to 85 minutes, less than or equal to 65 minutes, less than or equal to 50 minutes, or less than or equal to 25 minutes. Combinations of the above-referenced ranges are also possible (e.g., greater than or equal to 3 minutes and less than or equal to 200 minutes, greater than or equal to 6 minutes and less than or equal to 250 minutes). Other values of average lifetime are also possible. The lifetime may be determined by performing a flatsheet test according to the standard ISO 4020 (2001). The testing can be performed by flowing a test fluid through a 8 mm diameter filter media at a flow rate of the test fluid of 20 Lpm/m² and measuring the time, in minutes, required for the terminal pressure to increase by 70 kPa. The test fluid employed can be mineral oil having a viscosity of 4-6 cST at 23° C. and comprising carbon black as an organic contaminant and Mira 2 aluminum oxide as an inorganic contaminant. The carbon black may be present in the mineral oil in an amount of 1.25 g/20 L of mineral oil. The Mira 2 aluminum oxide may be present in the mineral oil in an amount of 5 g/20 L of mineral oil.

The filter media described herein may have a variety of suitable basis weights. In some embodiments, a filter media has a basis weight of greater than or equal to 15 g/m², greater than or equal to 20 g/m², greater than or equal to 25 g/m², greater than or equal to 30 g/m², greater than or equal to 40 g/m², greater than or equal to 50 g/m², greater than or equal to 75 g/m², greater than or equal to 100 g/m², greater than or equal to 125 g/m², greater than or equal to 150 g/m², greater than or equal to 200 g/m², greater than or equal to 250 g/m², greater than or equal to 300 g/m², greater than or equal to 350 g/m², greater than or equal to 400 g/m², greater than or equal to 450 g/m², or greater than or equal to 500 g/m². In some embodiments, a filter media has a basis weight of less than or equal to 550 g/m², less than or equal to 500 g/m², less than or equal to 450 g/m², less than or equal to 400 g/m², less than or equal to 350 g/m², less than or equal to 300 g/m², less than or equal to 250 g/m², less than or equal to 200 g/m², less than or equal to 150 g/m², less than or equal to 125 g/m², less than or equal to 100 g/m², less than or equal to 75 g/m², less than or equal to 50 g/m², less than or equal to 40 g/m², less than or equal to 30 g/m², less than or equal to 25 g/m², or less than or equal to 20 g/m². Combinations of the above-referenced ranges are also possible (e.g., greater than or equal to 15 g/m² and less than or equal to 550 g/m², greater than or equal to 20 g/m² and less than or equal to 350 g/m², or greater than or equal to 30 g/m² and less than or equal to 250 g/m²). Other ranges are also possible. The basis weight of a filter media may be determined in accordance with ISO 536:2012.

The surfaces of the filter media described herein may have a variety of suitable water contact angles. In some embodiments, a filter media has a surface with a water contact angle of greater than or equal to 45°, greater than or equal to 50°, greater than or equal to 60°, greater than or equal to 70°, greater than or equal to 80°, greater than or equal to 90°, greater than or equal to 100°, greater than or equal to 110°, greater than or equal to 120°, greater than or equal to 135°, greater than or greater than or equal to 150°, or greater than or equal to 175°. In some embodiments, a filter media has a surface with a water contact angle of less than or equal to 180°, less than or equal to 175°, less than or equal to 150°, less than or equal to 135°, less than or equal to 120°, less than or equal to 110°, less than or equal to 100°, less than or equal to 90°, less than or equal to 80°, less than or equal to 70°, less than or equal to 60°, or less than or equal to 50°. Combinations of the above-referenced ranges are also possible (e.g., greater than or equal to 45° and less than or equal to 180°, greater than or equal to 45° and less than or equal to 135°, greater than or equal to 45° and less than or equal to 120°, or greater than or equal to 50° and less than or equal to)120°. Other ranges are also possible. The contact angle of a surface of a filter media may be determined by in accordance with ASTM D5946 (2009).

The filter media described herein may have a variety of suitable mean flow pore sizes. In some embodiments, a filter media has a mean flow pore size of greater than or equal to 0.1 micron, greater than or equal to 0.125 microns, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 7.5 microns, greater than or equal to 10 microns, greater than or equal to 12.5 microns, or greater than or equal to 15 microns. In some embodiments, a filter media has a mean flow pore size of less than or equal to 20 microns, less than or equal to 15 microns, less than or equal to 12.5 microns, less than or equal to 10 microns, less than or equal to 7.5 microns, less than or equal to 5 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.75 microns, less than or equal to 0.5 microns, less than or equal to 0.4 microns, less than or equal to 0.3 microns, less than or equal to 0.25 microns, less than or equal to 0.2 microns, less than or equal to 0.15 microns, or less than or equal to 0.125 microns. Combinations of the above-referenced ranges are also possible (e.g., greater than or equal to 0.1 micron and less than or equal to 20 microns, greater than or equal to 0.1 micron and less than or equal to 10 microns, or greater than or equal to 0.2 microns and less than or equal to 5 microns). Other ranges are also possible. The mean flow pore size of a filter media may be determined in accordance with ASTM F316 (2003).

The filter media described herein may have a variety of suitable maximum pore sizes. In some embodiments, a filter media has a maximum pore size of greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 20 microns, or greater than or equal to 25 microns. In some embodiments, a filter media has a maximum pore size of less than or equal to 30 microns, less than or equal to 25 microns, less than or equal to 20 microns, less than or equal to 15 microns, less than or equal to 12.5 microns, less than or equal to 10 microns, less than or equal to 7.5 microns, less than or equal to 5 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.75 microns, less than or equal to 0.5 microns, less than or equal to 0.4 microns, less than or equal to 0.3 microns, or less than or equal to 0.25 microns. Combinations of the above-referenced ranges are also possible (e.g., greater than or equal to 0.2 microns and less than or equal to 30 microns, greater than or equal to 0.2 microns and less than or equal to 20 microns, or greater than or equal to 0.3 microns and less than or equal to 15 microns). Other ranges are also possible. The maximum pore size of a filter media may be determined in accordance with ASTM F316 (2003).

The filter media described herein may have a variety of suitable ratios of maximum pore size to mean flow pore size. In some embodiments, a filter media has a ratio of maximum pore size to mean flow pore size of greater than or equal to 1.3, greater than or equal to 1.5, greater than or equal to 1.75, greater than or equal to 2, greater than or equal to 2.5, greater than or equal to 3, greater than or equal to 4, greater than or equal to 5, greater than or equal to 7.5, greater than or equal to 10, greater than or equal to 12.5, or greater than or equal to 15. In some embodiments, a filter media has a ratio of maximum pore size to mean flow pore size of less than or equal to 20, less than or equal to 15, less than or equal to 12.5, less than or equal to 10, less than or equal to 7.5, less than or equal to 5, less than or equal to 4, less than or equal to 3, less than or equal to 2.5, less than or equal to 2, less than or equal to 1.75, or less than or equal to 1.5. Combinations of the above-referenced ranges are also possible (e.g., greater than or equal to 1.3 and less than or equal to 30, greater than or equal to 1.3 and less than or equal to 25, or greater than or equal to 1.3 and less than or equal to 20). Other ranges are also possible. The ratio of maximum pore size to mean flow pore size of a filter media may be determined by finding the maximum pore size and mean flow pore size in accordance with ASTM F316 (2003) and then dividing the maximum pore size by the mean flow pore size.

The filter media described herein may have a variety of suitable air permeabilities. In some embodiments, a filter media has an air permeability of 0.5 CFM, greater than or equal to 0.75 CFM, greater than or equal to 1 CFM, greater than or equal to 1.25 CFM, greater than or equal to 1.5 CFM, greater than or equal to 2 CFM, greater than or equal to 2.5 CFM, greater than or equal to 3 CFM, greater than or equal to 4 CFM, greater than or equal to 5 CFM, greater than or equal to 7.5 CFM, greater than or equal to 10 CFM, greater than or equal to 12.5 CFM, greater than or equal to 15 CFM, greater than or equal to 20 CFM, greater than or equal to 25 CFM, greater than or equal to 30 CFM, greater than or equal to 40 CFM, greater than or equal to 50 CFM, or greater than or equal to 75 CFM. In some embodiments, a filter media has an air permeability of less than or equal to 100 CFM, less than or equal to 75 CFM, less than or equal to 50 CFM, less than or equal to 40 CFM, less than or equal to 30 CFM, less than or equal to 25 CFM, less than or equal to 20 CFM, less than or equal to 15 CFM, less than or equal to 12.5 CFM, less than or equal to 10 CFM, less than or equal to 7.5 CFM, less than or equal to 5 CFM, less than or equal to 4 CFM, less than or equal to 3 CFM, less than or equal to 2.5 CFM, less than or equal to 2 CFM, less than or equal to 1.5 CFM, less than or equal to 1.25 CFM, less than or equal to 1 CFM, or less than or equal to 0.75 CFM. Combinations of the above-referenced ranges are also possible (e.g., greater than or equal to 0.5 CFM and less than or equal to 100 CFM, greater than or equal to 1 CFM and less than or equal to 150 CFM, or greater than or equal to 1 CFM and less than or equal to 50 CFM). Other ranges are also possible. The air permeability of a filter media may be determined in accordance with ASTM Test Standard D737-04 (2016) at a pressure of 125 Pa.

In some embodiments, a filter media described herein may be a component of a filter element. That is, the filter media may be incorporated into an article suitable for use by an end user. Non-limiting examples of suitable filter elements include flat panel filters, V-bank filters (comprising, e.g., between 1 and 24 Vs), cartridge filters, cylindrical filters, conical filters, and curvilinear filters. Filter elements may have any suitable height (e.g., between 2 inches and 124 inches for flat panel filters, between 4 inches and 124 inches for V-bank filters, between 1 inch and 124 inches for cartridge and cylindrical filter media). Filter elements may also have any suitable width (between 2 inches and 124 inches for flat panel filters, between 4 inches and 124 inches for V-bank filters). Some filter media (e.g., cartridge filter media, cylindrical filter media) may be characterized by a diameter instead of a width; these filter media may have a diameter of any suitable value (e.g., between 1 inch and 124 inches). Filter elements typically comprise a frame, which may be made of one or more materials such as cardboard, aluminum, steel, alloys, wood, and polymers.

The filter media described herein may be suitable for filtering a variety of fluids. For instance, the filter media described herein may be liquid filters and/or air filters. The liquid may be water, fuel, or another fluid. Non-limiting examples of suitable fuels include diesel fuel, hydraulic fuel, oil and other hydrocarbon liquids. Some methods may comprise employing a filter media described herein to filter a fluid, such as to filter a liquid (e.g., water, fuel) or to filter air. The method may comprise passing a fluid (e.g., a fluid to be filtered) through the filter media. When the fluid is passed through the filter media, the components filtered from the fluid may be retained on an upstream side of the filter media and/or within the filter media. The filtrate may be passed through the filter media.

Paragraph 1: In some embodiments, a filter media is provided. The filter media comprises a non-woven fiber web comprising a plurality of continuous nanofibers and a backer layer. The plurality of nanofibers comprises a plurality of nanoparticles. The plurality of nanoparticles makes up less than or equal to 15 wt % of the plurality of nanofibers. A solidity of the non-woven fiber web is less than or equal to a solidity of the backer layer.

Paragraph 2: In some embodiments, a filter media is provided. The filter media comprises a non-woven fiber web comprising a plurality of continuous nanofibers having an average diameter of less than or equal to 250 nm and a backer layer. The plurality of nanofibers comprises a plurality of nanoparticles at least partially embedded therein. The plurality of nanoparticles makes up less than or equal to 15 wt % of the plurality of nanofibers. A solidity of the non-woven fiber web is less than or equal to a solidity of the backer layer.

Paragraph 3: In some embodiments, a filter media is provided. The filter media comprises a non-woven fiber web comprising a plurality of continuous nanofibers having an average diameter of less than or equal to 250 nm and a backer layer. The plurality of nanofibers comprises a plurality of nanoparticles at least partially embedded therein. The plurality of nanoparticles makes up less than or equal to 15 wt % of the plurality of nanofibers. A solidity of the non-woven fiber web is less than or equal to a solidity of the backer layer. A ratio of an average diameter of the nanofibers to an average diameter of the nanoparticles is greater than or equal to 1.5 and less than or equal to 15.

Paragraph 4: In some embodiments, the nanoparticles of a filter media described in any one of paragraphs 1-3 have an average diameter of greater than or equal to 5 nm and less than or equal to 50 nm.

Paragraph 5: In some embodiments, a ratio of an average diameter of the nanofibers to an average diameter of the nanoparticles is greater than or equal to 1.5 and less than or equal to 15 for a filter media described in any one of paragraphs 1-4.

Paragraph 6: In some embodiments, the plurality of nanoparticles makes up greater than or equal to 1 wt % and less than or equal to 10 wt % of the plurality of nanofibers for a filter media described in any one of paragraphs 1-5.

Paragraph 7: In some embodiments, at least a portion of the nanoparticles are located in an interior of a nanofiber for a filter media described in any one of paragraphs 1-6.

Paragraph 8: In some embodiments, at least a portion of the plurality of nanoparticles are located at a surface of a nanofiber for a filter media described in any one of paragraphs 1-7.

Paragraph 9: In some embodiments, the nanoparticles of a filter media described in any one of paragraphs 1-8 are uncharged.

Paragraph 10: In some embodiments, the nanoparticles of a filter media described in any one of paragraphs 1-9 comprise an inorganic material.

Paragraph 11: In some embodiments, the plurality of nanoparticles of a filter media described in any one of paragraphs 1-10 comprises silica nanoparticles.

Paragraph 12: In some embodiments, the nanofibers of a filter media described in any one of paragraphs 1-11 have an average diameter of greater than or equal to 50 nm and less than or equal to 250 nm.

Paragraph 13: In some embodiments, the nanofibers of a filter media described in any one of paragraphs 1-12 are electrospun nanofibers.

Paragraph 14: In some embodiments, the nanofibers of a filter media described in any one of paragraphs 1-13 comprise a Nylon.

Paragraph 15: In some embodiments, the basis weight of the non-woven fiber web of the filter media described in any one of paragraphs 1-14 is greater than or equal to 0.05 g/m² and less than or equal to 10 g/m².

Paragraph 16: In some embodiments, a filter element comprising the filter media of any one of paragraphs 1-15 is provided.

Paragraph 17: In some embodiments, the filter element of claim 16 is a filter element of a type selected from the group consisting of: a flat panel filter, a V-bank filter, a cartridge filter, a cylindrical filter, a conical filter, and a curvilinear filter.

Paragraph 18: In some embodiments, a method comprising passing a fluid through a filter media described in any one of paragraphs 1-15 is provided.

Paragraph 19: In some embodiments, a method comprising passing a fluid through a filter element described in any one of paragraphs 16-17 is provided.

### EXAMPLE 1

This Example describes the fabrication and testing of filter media comprising a nanofiber layer including nanofibers formed of Nylon 6 and fumed silica nanoparticles. The fumed silica nanoparticles were embedded within the nanofibers.

The nanofiber layer was fabricated by electrospinning a nanofiber layer from a precursor fluid comprising Nylon 6, fumed silica nanoparticles having a specific surface area of 300 m²/g and an average diameter of 15 nm, and a mixture of organic acids. The fumed silica nanoparticles and Nylon 6 together made up 13.5 wt % of the precursor fluid. A control nanofiber layer was fabricated by electrospinning a precursor fluid comprising 13.5 wt % Nylon 6 in the organic acids. The amounts of fumed silica nanoparticles and Nylon 6 in each precursor fluid are listed below in Table 1.

TABLE 1

| | | | Wt % | | |
|---|---|---|---|---|---|
| | | | fumed silica | | |
| | Wt % Nylon 6 in | | nanoparticles in | | |
| Precursor | precursor fluid | | precursor fluid | | |
| Fluid No. | (in solids) | | (in solids) | | Viscosity |
| 1 | 13.5 | (100) | 0 | (0) | 230 cPs |
| 2 | 13.1625 | (97.5) | 0.3375 | (2.5) | 280 cPs |

Each precursor fluid was electrospun at constant electric field and constant humidity onto a non-woven fiber web backer layer to form filter media samples of varying basis weights comprising a nanofiber layer disposed on the backer layer.

Samples of each type of filter media (e.g., comprising nanofiber layers including and not including nanoparticles) having the same values of air permeability as each other were obtained and compared to each other. The average diameter of the fibers in each nanofiber layer was measured using SEM, and the air permeability, gamma, initial beta ratio at 4 microns, initial beta ratio at 1.5 microns, and contact angle were measured as described elsewhere herein.

The samples including a nanofiber layer comprising fumed silica nanoparticles outperformed the samples including a nanofiber layer lacking fumed silica nanoparticles in a variety of ways, as summarized below in Table 2. As can be seen from Table 2, the sample including a nanofiber layer comprising fumed silica nanoparticles had a higher value of gamma, a higher mean flow pore size, and higher values of initial beta ratio at 4 microns and 1.5 microns than the sample including a nanofiber layer lacking fumed silica nanoparticles. The higher mean flow pore size of the samples including a nanofiber layer comprising fumed silica nanoparticles is indicative of a more open filter media, with lower solidity of the nanofiber layer therein. The improved structural integrity of this nanofiber layer is likely the cause of the enhanced initial beta ratio values.

TABLE 2

| | Nanofiber | Nanofiber |
|---|---|---|
| | layer formed | layer formed |
| | from Precursor | from Precursor |
| | Fluid No. 1 | Fluid No. 2 |
| Average fiber diameter | 93 ± 25 nm | 99 ± 29 nm |
| Air permeability | 5 ± 1 CFM | 5 ± 1 CFM |
| Gamma at the MPPS | 43 ± 6 | 51 ± 4 |
| Contact angle | 84 ± 12° | 102 ± 12° |
| Basis weight | 1.1 ± 0.2 | 0.7 ± 0.2 |
| Mean flow pore diameter | 0.4 ± 0.05 | 0.5 ± 0.05 |
| Initial beta ratio at 4 microns | 1250 ± 500 | 2000 ± 750 |
| Initial beta ratio at 1.5 microns | 180 ± 250 | 1000 |

### EXAMPLE 2

This Example describes the fabrication and assessment of solidity of nanofiber layers including nanofibers formed of Nylon 6 and fumed silica nanoparticles at varying basis weights.

Nanofiber layers were fabricated as described above in Example 1, but were electrospun onto glass slides taped onto backer layers and onto portions of the backer layers uncovered by the glass slides. The thickness of the nanofiber layer on the glass slide was measured using a manual caliper gauge. This was accomplished by first zeroing the gauge on an uncoated portion of the glass slide, measuring the thickness of the glass slide and nanofiber layer together under an applied pressure of 2.58 kPa at five locations spaced less than 1 inch apart from each other, and then averaging the measured thickness. The basis weight of the nanofiber layer was determined by: (1) using an analytical balance to weigh a portion of the backer layer onto which the nanofiber layer was directly electrospun with known area; (2) removing the nanofiber layer from the backer layer; (3) using an analytical balance to weigh the same portion of the backer layer again; (4) subtracting the second measured weight from the first measured weight; and (5) dividing the resultant value by the known area. Then, the solidity of each nanofiber layer was calculated as described elsewhere herein.

As shown in FIG. 4, the nanofiber layers comprising nanoparticles had advantageously lower values of solidity than the nanofiber layers not including fumed silica nanoparticles. In

FIG. 4, every nanofiber layer lacking fumed silica nanoparticles (labeled PA6 in FIG. 4) had a higher solidity than every nanofiber layer including fumed silica nanoparticles (labeled PA6/SiO2 in FIG. 4). The data shown in FIG. 4 is also summarized below in Table 3.

TABLE 3

| | | |
|---|---|---|
| Average basis weight | Average thickness | Solidity |

Samples of filter media formed from Precursor Fluid No. 1

| | | |
|---|---|---|
| 0.6 g/m² | 3.0 microns | 17% |
| 1.2 g/m² | 3.4 microns | 32% |
| 1.5 g/m² | 7.2 microns | 19% |
| 2.3 g/m² | 5.6 microns | 37% |
| 2.9 g/m² | 8.6 microns | 29% |

Samples of filter media formed from Precursor Fluid No. 2

| | | |
|---|---|---|
| 1.2 g/m² | 20.3 microns | 5% |
| 2.0 g/m² | 11.2 microns | 16% |
| 2.3 g/m² | 22.9 microns | 8% |
| 3.3 g/m² | 23.5 microns | 12% |
| 3.6 g/m² | 61.0 microns | 5% |

### EXAMPLE 3

This Example describes the fabrication and testing of filter media comprising a nanofiber layer including nanofibers formed of Nylon 6 and fumed silica nanoparticles in varying concentrations.

Two filter media were fabricated as described above in Example 1. A third filter media was fabricated as described in Example 1, but from a dispersion including 0.675 wt % fumed silica nanoparticles and 12.825 wt % Nylon 6 in a mixture of organic acids. In this dispersion, the fumed silica made up 5 wt % of the solids and the Nylon 6 made up 95 wt % of the solids.

Two sets of samples of each type of filter media (e.g., comprising nanofiber layers including and not including nanoparticles) having the same values of air permeability were obtained and tested as described in Example 1. Tables 4 and 5, below, list several physical parameters of each type of filter media. Table 4 shows data from samples having air permeabilities of approximately 4.5-5.5 CFM, and Table 5 shows data from samples having air permeabilities of approximately 1.8-1.9 CFM. As shown in Table 4, the filter media including a nanofiber layer comprising 2.5 wt % fumed silica nanoparticles had a larger value of gamma compared to the filter media including a nanofiber layer lacking fumed silica nanoparticles, and compared to the filter media including a nanofiber layer comprising 5 wt % fumed silica nanoparticles. As shown in Tables 4 and 5, the filter media including a nanofiber layer comprising 2.5 wt % fumed silica nanoparticles had a mean flow pore size comparable to the filter media including a nanofiber layer comprising 5 wt % fumed silica nanoparticles, and a larger mean flow pore size than the filter media comprising a nanofiber layer lacking fumed silica nanoparticles. It should be noted that these filter media were slightly damaged during rolling and unrolling and that those described in Example 1 were not damaged, causing the values of gamma and mean flow pore size measured in this Example to be different than those measured in Example 1.

TABLE 4

| | | | Nanofiber formed |
|---|---|---|---|
| | | | from dispersion including |
| | Nanofiber layer | Nanofiber layer | 0.675 wt % fumed |
| | formed from | formed from | silica nanoparticles and |
| | Precursor | Precursor | 12.825 wt % Nylon 6 in |
| | Fluid No. 1 | Fluid No. 2 | mixture of organic acids |
| Average fiber | 100 ± 29 nm | 103 ± 8 nm | 102 ± 13 nm |
| diameter | | | |
| Air permeability | 4.3 ± 0.4 CFM | 5.4 ± 0.7 CFM | 4.9 ± 0.4 CFM |
| Gamma at the MPPS | 41 ± 4 | 44 ± 10 | 20 ± 4 |
| Mean flow pore | 0.45 ± 0.08 microns | 0.50 ± 0.03 microns | Not measured |
| diameter | | | |
| Basis weight | 0.6 ± 0.2 g/m² | 0.8 ± 0.2 g/m² | 1.4 ± 0.08 g/m² |

TABLE 5

| | | | Nanofiber formed |
|---|---|---|---|
| | | | from dispersion |
| | | | including |
| | | | 0.675 wt% fumed |
| | Nanofiber layer | Nanofiber layer | silicana noparticles |
| | formed from | formed from | and 12.825 wt % |
| | Precursor | Precursor | Nylon 6 in mixture |
| | Fluid No. 1 | Fluid No. 2 | of organic acids |
| Average fiber | 102 nm | 102 ± 8 nm | 99 ± 7 nm |
| diameter | | | |
| Air permeability | 1.9 CFM | 1.8 ± 0.1 CFM | 1.8 ± 0.2 CFM |
| Mean flow pore | 0.30 ± 0.04 | 0.34 ± 0.05 | 0.34 ± 0.01 |
| diameter | microns | microns | microns |
| Basis weight | 3.15 ± 0.8 g/m² | 3.7 ± 1.8 g/m² | 4.9 ± 0.5 g/m² |

### EXAMPLE 4

This Example describes the fabrication and imaging of nanofiber layers including nanofibers formed of Nylon 6 and fumed silica nanoparticles in varying concentrations.

Two nanofiber layers were fabricated as described in Example 1: one from a dispersion having the composition of Precursor Fluid No. 2 (in which the fumed silica nanoparticles made up 2.5 wt % of the solids), and one from a dispersion comprising 0.405 wt % fumed silica nanoparticles and 13.095 wt % Nylon 6 in a mixture of organic acids (in which the fumed silica nanoparticles made up 3 wt % of the solids). The viscosity of the latter dispersion did not differ significantly from the viscosity of the former dispersion.

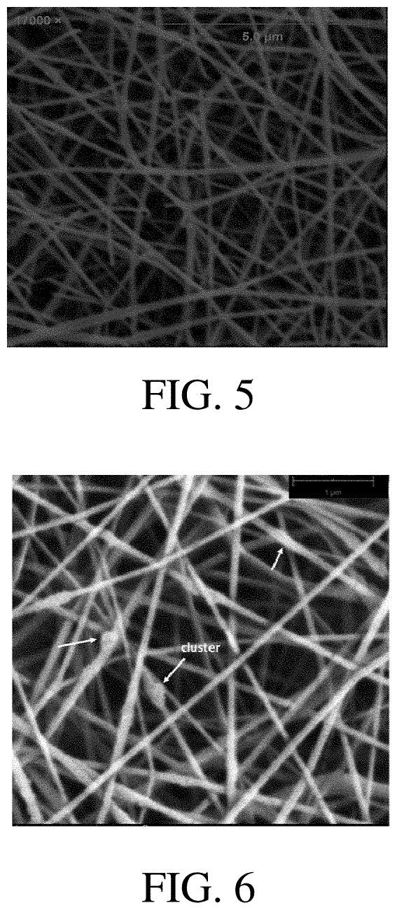

SEM images of exemplary nanofiber layers including 2.5 wt % fumed silica nanoparticles and 5 wt % fumed silica nanoparticles disposed on backer layers are shown in FIGS. 5 and 6, respectively. The nanofiber layers were lightly sputter coated with gold prior to SEM imaging.

The fumed silica nanoparticles are not visible in FIG. 5, but are visible in FIG. 6 (some are indicated by arrows therein).

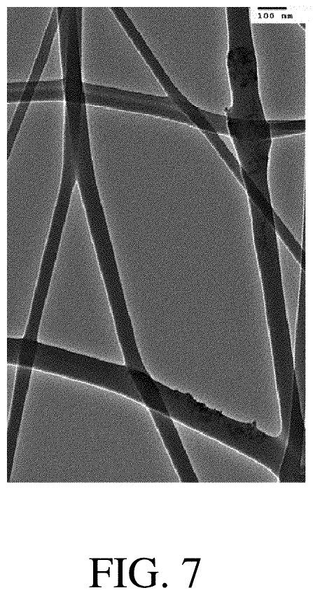

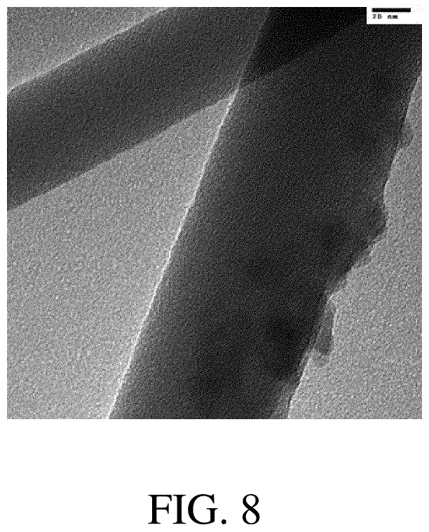

Further imaging was performed on samples fabricated from the precursor fluids described in Example 1, but which were deposited directly onto a 200 mesh copper TEM grid. TEM images of a nanofiber layer including 2.5 wt % fumed silica nanoparticles is shown in FIGS. 7 and 8. These images clearly show the presence of the fumed silica nanoparticles in the nanofibers.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A filter media, comprising:
a non-woven fiber web comprising a plurality of continuous nanofibers having an average diameter of less than or equal to 250 nm; and
a backer layer, wherein:
the plurality of nanofibers comprises a plurality of nanoparticles at least partially embedded therein;
the plurality of nanoparticles makes up less than or equal to 15 wt % of the plurality of nanofibers; and
a solidity of the non-woven fiber web is less than or equal to a solidity of the backer layer.

2. The filter media of claim 1, wherein the nanoparticles have an average diameter of greater than or equal to 5 nm and less than or equal to 50 nm.

3. The filter media of claim 1, wherein a ratio of an average diameter of the nanofibers to an average diameter of the nanoparticles is greater than or equal to 1.5 and less than or equal to 15.

4. The filter media of claim 1, wherein the plurality of nanoparticles makes up greater than or equal to 1 wt % and less than or equal to 10 wt % of the plurality of nanofibers.

5. The filter media of claim 1, wherein at least a portion of the nanoparticles are located in an interior of a nanofiber.

6. The filter media of claim 1, wherein at least a portion of the plurality of nanoparticles are located at a surface of a nanofiber.

7. The filter media of claim 1, wherein the nanoparticles are uncharged.

8. The filter media of claim 1, wherein the nanoparticles comprise an inorganic material.

9. The filter media of claim 1, wherein the plurality of nanoparticles comprises silica nanoparticles.

10. The filter media of claim 1, wherein the nanofibers have an average diameter of greater than or equal to 50 nm.

11. The filter media of claim 1, wherein the nanofibers are electrospun nanofibers.

12. The filter media of claim 1, wherein the nanofibers comprise a Nylon.

13. The filter media of claim 1, wherein the basis weight of the non-woven fiber web is greater than or equal to 0.05 g/m² and less than or equal to 10 g/m².

14. A filter element comprising the filter media of claim 1.

15. The filter element of claim 14, wherein the filter element is a filter element of a type selected from the group consisting of: a flat panel filter, a V-bank filter, a cartridge filter, a cylindrical filter, a conical filter, and a curvilinear filter.

16. A method comprising passing a fluid through the filter media of claim 1.

17. A method comprising passing a fluid through the filter element of claim 14.

18. A method as in claim 14, wherein the fluid is a fuel.
